(19) United States
(12) Patent Application Publication
(10) Pub. No.: US 2026/0113777 A1
(43) Pub. Date: Apr. 23, 2026

(54) PROTECTION FOR ENHANCED LONG RANGE TRANSMISSIONS

(71) Applicant: QUALCOMM Incorporated, San Diego, CA (US)

(72) Inventors: Lin YANG, San Diego, CA (US); Alfred ASTERJADHI, San Diego, CA (US); George CHERIAN, San Diego, CA (US); Youhan KIM, Saratoga, CA (US); Bin TIAN, San Diego, CA (US)

(21) Appl. No.: 19/360,807

(22) Filed: Oct. 16, 2025

Related U.S. Application Data
(60) Provisional application No. 63/711,139, filed on Oct. 23, 2024.

(51) Int. Cl. H04W 74/0808

(52) U.S. Cl. CPC H04W 74/0808

(57) ABSTRACT

This disclosure provides methods, components, devices and systems for protection for enhanced long range (ELR) transmissions. Aspects more specifically relate request to send (RTS) and clear to send (CTS) signaling exchanges for configuration of an ELR physical layer protocol data unit (PPDU) that protects ELR RTS/CTS frames from interference. For example, a first wireless device may indicate, via a first frame, a modified network allocation vector (NAV) timeout duration that accounts for a full duration of an ELR frame. In some examples, the modified NAV timeout duration may be calculated to account for a difference in data rate of the ELR frame relative to non-ELR frames. For example, the first wireless device may transmit a first frame prior to an ELR RTS/CTS frame, and the first frame may indicate, via a duration field, the modified NAV timeout duration that is calculated in accordance with the ELR RTS/CTS frame.

### CROSS REFERENCE

The present Application for Patent claims benefit of U.S. Provisional Patent Application No. 63/711,139 by YANG et al., entitled “PROTECTION FOR ENHANCED LONG RANGE TRANSMISSIONS,” filed Oct. 23, 2024, assigned to the assignee hereof, and which is expressly incorporated by reference in its entirety herein.

### TECHNICAL FIELD

This disclosure relates generally to wireless communication and, more specifically, to protection for enhanced long range (ELR) transmissions.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

In some wireless systems, nodes may sense a medium before transmitting to prevent simultaneous transmissions with other devices. In some examples, a device may sense the medium but not detect one or more other nodes because they are beyond its sensing range. Thus, the device may not know when other nodes are transmitting. This may result in simultaneous transmissions to a central node, which may cause interference and corruption of the transmitted data. This interference may result in increased network overhead and may delay communication.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication at a first wireless device. The method may include transmitting, to a second wireless device in accordance with a first data rate, a first frame, the first frame including a duration field that indicates a network allocation vector (NAV) timeout duration, the NAV timeout duration calculated in accordance with a duration of a second frame that is communicated in accordance with a second data rate less than the first data rate, communicating the second frame with the second wireless device in accordance with the second data rate and within the NAV timeout duration, and transmitting, at least partially after the NAV timeout duration, a physical layer protocol data unit (PPDU) including a first preamble, a second preamble different from the first preamble and associated with an enhanced long range (ELR) protocol, and data associated with the second wireless device.

Another innovative aspect of the subject matter described in this disclosure can be implemented in an apparatus for wireless communication at a first wireless device. The apparatus may include a processing system that includes processor circuitry and memory circuitry that stores code. The processing system may be configured to cause the apparatus to transmit, to a second wireless device in accordance with a first data rate, a first frame, the first frame including a duration field that indicates a network allocation vector (NAV) timeout duration, the NAV timeout duration calculated in accordance with a duration of a second frame that is communicated in accordance with a second data rate less than the first data rate, communicate the second frame with the second wireless device in accordance with the second data rate and within the NAV timeout duration, and transmit, at least partially after the NAV timeout duration, a physical layer protocol data unit (PPDU) including a first preamble, a second preamble different from the first preamble and associated with an enhanced long range (ELR) protocol, and data associated with the second wireless device.

Another innovative aspect of the subject matter described in this disclosure can be implemented in an apparatus for wireless communication at a first wireless device. The apparatus may include means for transmitting, to a second wireless device in accordance with a first data rate, a first frame, the first frame including a duration field that indicates a network allocation vector (NAV) timeout duration, the NAV timeout duration calculated in accordance with a duration of a second frame that is communicated in accordance with a second data rate less than the first data rate, means for communicating the second frame with the second wireless device in accordance with the second data rate and within the NAV timeout duration, and means for transmitting, at least partially after the NAV timeout duration, a physical layer protocol data unit (PPDU) including a first preamble, a second preamble different from the first preamble and associated with an enhanced long range (ELR) protocol, and data associated with the second wireless device.

Another innovative aspect of the subject matter described in this disclosure can be implemented in a non-transitory computer-readable medium storing code for wireless communication at a first wireless device. The code may include instructions executable by one or more processors to transmit, to a second wireless device in accordance with a first data rate, a first frame, the first frame including a duration field that indicates a network allocation vector (NAV) timeout duration, the NAV timeout duration calculated in accordance with a duration of a second frame that is communicated in accordance with a second data rate less than the first data rate, communicate the second frame with the second wireless device in accordance with the second data rate and within the NAV timeout duration, and transmit, at least partially after the NAV timeout duration, a physical layer protocol data unit (PPDU) including a first preamble, a second preamble different from the first preamble and associated with an enhanced long range (ELR) protocol, and data associated with the second wireless device.

In some examples of the method, apparatuses, and non-transitory computer-readable medium described herein, the first frame includes a receiver address field that indicates the second wireless device different from the first wireless device.

In some examples of the method, apparatuses, and non-transitory computer-readable medium described herein, the first data rate is associated with a non-ELR protocol and the second data rate is associated with the ELR protocol, and the second data rate is less than the first data rate in accordance with the ELR protocol.

In some examples of the method, apparatuses, and non-transitory computer-readable medium described herein, the first frame includes an unsolicited clear to send (CTS) frame associated with a non-ELR protocol and the second frame comprises an ELR-CTS frame transmitted by the first wireless device.

In some examples of the method, apparatuses, and non-transitory computer-readable medium described herein, the first frame includes an unsolicited CTS frame associated with a non-ELR protocol and the second frame comprises an ELR request to send (RTS) frame received by the first wireless device.

In some examples of the method, apparatuses, and non-transitory computer-readable medium described herein, the first frame includes an unsolicited clear to send (CTS) frame, a request to send (RTS) frame, or a quality of service (QoS) null frame, and the second frame includes one of a second clear to send (CTS) frame, a second RTS frame, a second QoS null frame, or an acknowledgement (ACK) frame.

In some examples of the method, apparatuses, and non-transitory computer-readable medium described herein, the first frame includes the unsolicited CTS frame and the second frame includes the second CTS frame, and the method, apparatuses, and non-transitory computer-readable medium may include further operations, features, means, or instructions for transmitting, to the second wireless device after transmitting the first frame, a third RTS frame in accordance with the first data rate and receiving, from the second wireless device in accordance with the second data rate, the second CTS frame responsive to the third RTS frame.

In some examples of the method, apparatuses, and non-transitory computer-readable medium described herein, the duration field in the first frame indicates a duration value that may be a combination of the NAV timeout duration, a short interframe space (SIFS) duration, and a duration of the third RTS frame.

In some examples of the method, apparatuses, and non-transitory computer-readable medium described herein, the NAV timeout duration may be further calculated in accordance with a duration of the second CTS frame with the second data rate.

In some examples of the method, apparatuses, and non-transitory computer-readable medium described herein, the first frame includes the QoS null frame and the second frame includes the ACK frame, and the method, apparatuses, and non-transitory computer-readable medium may include further operations, features, means, or instructions for receiving, from the second wireless device in accordance with the second data rate, the ACK frame responsive to the QoS null frame, where the duration field in the first frame indicates a duration value that may be in accordance with a length of the ACK frame and the second data rate and may be in accordance with a set of multiple short interframe space (SIFS) durations.

In some examples of the method, apparatuses, and non-transitory computer-readable medium described herein, the first frame includes the RTS frame and the second frame includes the second CTS frame, and the method, apparatuses, and non-transitory computer-readable medium may include further operations, features, means, or instructions for receiving, from the second wireless device in accordance with the second data rate, the second CTS frame responsive to the RTS frame, where the duration field in the first frame indicates a duration value that may be a combination of a duration of the second CTS frame, a set of multiple short interframe space (SIFS) durations, a duration of the PPDU, and a duration of a second ACK frame, the second ACK frame received in accordance with the second data rate and responsive to the PPDU.

In some examples of the method, apparatuses, and non-transitory computer-readable medium described herein, the first frame includes the RTS frame and the second frame includes the second CTS frame, and the method, apparatuses, and non-transitory computer-readable medium may include further operations, features, means, or instructions for receiving, from the second wireless device in accordance with the first data rate, a third CTS frame responsive to the RTS frame and receiving, from the second wireless device after the third CTS frame, the second CTS frame in accordance with the second data rate.

In some examples of the method, apparatuses, and non-transitory computer-readable medium described herein, the duration field in the first frame indicates a duration value that may be a combination of a duration of the second CTS frame, a set of multiple short interframe space (SIFS) durations, a duration of the third CTS frame, a duration of the PPDU, and a duration of a second ACK frame, the second ACK frame received in accordance with the second data rate and responsive to the PPDU.

In some examples of the method, apparatuses, and non-transitory computer-readable medium described herein, the first frame includes the unsolicited CTS frame and the second frame includes the second RTS frame, and the method, apparatuses, and non-transitory computer-readable medium may include further operations, features, means, or instructions for transmitting, to the second wireless device after transmitting the unsolicited CTS frame, the second RTS frame in accordance with the second data rate and receiving, from the second wireless device in accordance with the first data rate, a third CTS frame responsive to the second RTS frame.

In some examples of the method, apparatuses, and non-transitory computer-readable medium described herein, the duration field in the first frame indicates a duration value that may be in accordance with a length of the second RTS frame and the second data rate, may be in accordance with a length of the third CTS frame and the first data rate, and may be in accordance with a set of multiple short interframe space (SIFS) durations.

In some examples of the method, apparatuses, and non-transitory computer-readable medium described herein, the first frame includes the unsolicited CTS frame and the second frame includes the second QoS null frame, and the method, apparatuses, and non-transitory computer-readable medium may include further operations, features, means, or instructions for transmitting, to the second wireless device after transmitting the unsolicited CTS frame, the second QoS null frame in accordance with the second data rate and receiving, from the second wireless device in accordance with the first data rate, a second acknowledgement frame responsive to the second QoS null frame.

In some examples of the method, apparatuses, and non-transitory computer-readable medium described herein, the duration field in the first frame indicates a duration value that may be in accordance with a length of the second QoS null frame and the second data rate, may be in accordance with a length of the second ACK frame and the first data rate, and may be in accordance with a set of multiple short interframe space (SIFS) durations.

In some examples of the method, apparatuses, and non-transitory computer-readable medium described herein, the first frame includes a single copy of first information associated with the unsolicited CTS frame, the RTS frame, or the QoS null frame, the single copy of the first information in accordance with the first data rate, and the second frame includes two or more repetitions of second information associated with the second CTS frame, the second RTS frame, the second QoS null frame, or the ACK frame, the two or more repetitions of the second information in accordance with the second data rate.

In some examples of the method, apparatuses, and non-transitory computer-readable medium described herein, the first wireless device may be one of an ELR station (STA) and an access point (AP) and the second wireless device may be the other of the ELR STA or the AP.

Details of one or more aspects of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network that supports protection for enhanced long range (ELR) transmissions.

FIG. 2 shows an example protocol data unit (PDU) usable for communications between a wireless access point (AP) and one or more wireless stations (STAs) that supports protection for ELR transmissions.

FIG. 3 shows an example physical layer (PHY) protocol data unit (PPDU) usable for communications between a wireless AP and one or more wireless STAs that supports protection for ELR transmissions.

FIG. 4 shows a hierarchical format of an example PPDU usable for communications between a wireless AP and one or more wireless STAs that supports protection for ELR transmissions.

FIG. 5 shows an example of an ELR frame format usable for communications between a wireless AP and one or more wireless STAs (such as an ELR STA) that supports protection for ELR transmissions.

FIG. 6 shows an example of a timing diagram that shows downlink communications between a wireless AP and one or more wireless STAs (such as an ELR STA) that support protection for ELR transmissions.

FIG. 7 shows an example of a timing diagram that shows downlink communications between a wireless AP and one or more wireless STAs (such as an ELR STA) that support protection for ELR transmissions.

FIG. 8 shows an example of a timing diagram that shows downlink communications between a wireless AP and one or more wireless STAs (such as an ELR STA) that support protection for ELR transmissions.

FIG. 9 shows an example of a timing diagram that shows downlink communications between a wireless AP and one or more wireless STAs (such as an ELR STA) that support protection for ELR transmissions.

FIG. 10 shows an example of a timing diagram that shows uplink communications between a wireless STA (such as an ELR STA) and a wireless AP that support protection for ELR transmissions.

FIG. 11 shows an example of a timing diagram that shows uplink communications between a wireless STA (such as an ELR STA) and a wireless AP that support protection for ELR transmissions.

FIG. 12 shows a block diagram of an example wireless communication device that supports protection for ELR transmissions.

FIG. 13 shows a flowchart illustrating an example process performable by or at a first wireless device that supports protection for ELR transmissions.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a wireless communication device may transmit a physical layer (PHY) protocol data unit (PPDU) to an intended receiver. The PPDU may include a preamble portion and a data portion. One or more fields of the preamble portion may indicate one or more of a format, a version, or a mode associated with the PPDU, and the data portion may carry a data payload in accordance with the indicated one or more of the format, the version, or the mode. The wireless communication device, which may be an access point (AP) or a station (STA), among other examples, may generate and transmit the PPDU in accordance with one of various formats. For example, depending on a capability of the wireless communication device, the wireless communication device may transmit the PPDU in accordance with an extremely high throughput (EHT) format or an ultra-high reliability (UHR) format, among other examples. In some networks, a wireless communication device may support enhanced long range (ELR) transmissions, which may extend a coverage associated with the wireless communication device (and which may be referred to herein as “extended” long range transmissions). The ELR transmissions may be associated with a dedicated PPDU format in some examples to facilitate a use of a relatively higher transmit power or to otherwise increase a range of the PPDU. In some networks, ELR transmissions may use a lower data rate (such as 1.7 Mb/s) relative to a data rate used for non-ELR transmissions (such as 6 Mb/s).

In some examples, the wireless communication device may implement ELR transmissions to account for a power imbalance between the wireless communication device and another wireless communication device. For example, a first wireless communication device (such as a STA) may support a first transmission power based on a capability of the first wireless communication device, while a second wireless communication device (such as an AP) may support a second transmission power that is higher than the first transmission power based on a capability of the second wireless communication device. The AP may transmit signaling (such as downlink signaling) with a larger (such as a longer) range than the STA because the second transmission power is higher than the first transmission power (such as a downlink transmission power). However, if the STA is operating at an edge of a basic service set (BSS) associated with the AP, the AP may be unable to receive signaling (such as uplink signaling) from the STA due to the reduced transmission power of the STA (such as an uplink transmission power). Accordingly, the STA may implement ELR transmissions to communicate with the AP while accounting for the power imbalance (such as an uplink/downlink power imbalance) between the STA and the AP.

Access to a wireless communication medium for communications of PPDUs may be contention-based, where the wireless communication device senses the medium to determine if it is available or not before transmitting a PPDU. In some examples, a first device (such as a STA) may be transmitting to a central node (such as an AP) but may be beyond the detection range of a second device (such as another STA). If the second device senses the medium, it may not detect the transmission of the first device and may begin transmitting, which may result in interference at the central node. These so-called hidden nodes may exist within a BSS or may exist on a different, overlapping basic service set (OBSS). In some other examples, some devices may not sense the medium before sending, which may result in interference if any other nearby device is also transmitting.

Based on the greater communication range associated with ELR transmissions, a relatively large quantity of devices within a network may “hear” or detect ELR transmissions, including both devices relatively near to a transmitting device and devices relatively far from the transmitting device. To help prevent interference at a central device (such as a wireless AP) in a WLAN, nodes may sense the medium and send a request to send (RTS) frame. If the receiving node is free, it may send a clear to send (CTS) frame. Nodes in a WLAN may represent one or more APs or STAs and together may make up a basic service set (BSS).

In some examples, a duration field included in an RTS frame may indicate a network allocation vector (NAV) that reserves the wireless communication medium for a duration. Neighboring STAs (such as bystanders) that detect the RTS frame may update their own NAV setting in response to the duration indicated in the duration field of the RTS frame. If a neighboring STA determines that no transmission has been communicated over the wireless communication medium for a threshold duration (such as a NAV timeout duration), the neighboring STA may reset its own NAV setting to zero.

In some examples, ELR RTS frames and ELR CTS frames may be exchanged between STA and AP to configure (such as schedule, reserve) transmission of the ELR PPDU. However, ELR RTS/CTS frames may have a longer duration compared to legacy RTS/CTS frames and may be communicated with a lower data rate, which may result in the ELR RTS/CTS frames lacking protection from interference via transmissions from the neighboring STAs. For example, a calculation of the NAV timeout duration by the neighboring STAs in the wireless communication system may be based on the RTS/CTS frame having a first duration, when in fact the RTS/CTS frame has a longer duration. As a result, the NAV timeout duration may expire at a neighboring STA, thereby triggering a NAV reset indicating that the communication medium is available, and an uplink transmission from the neighboring STA in response to the NAV reset may cause the ELR RTS/CTS frame to be interfered with, resulting in data loss.

Various aspects relate generally to protection for ELR transmissions. Some aspects more specifically relate to changes to RTS/CTS signaling exchanges for configuration of an ELR PPDU that protects ELR RTS/CTS frames from cross-traffic interference. For example, a first wireless device may indicate, via a first frame, which may be a non-ELR frame, a modified NAV timeout duration (such as an updated NAV timeout duration) that accounts for a full duration of a second frame, which may be an ELR frame (such as an ELR RTS frame or an ELR CTS frame). In some examples, the modified NAV timeout duration may be calculated to account for a difference in data rate of the ELR frame relative to a different data rate (such as a higher data rate) of non-ELR frames. For example, the first wireless device may transmit a first frame (such as a CTS2Self Frame) prior to an ELR RTS/CTS frame, and the first frame may indicate, via a duration field, the modified NAV timeout duration that is calculated in accordance with a relatively lower data rate (such as 1.7 Mb/s) by which the ELR RTS/CTS frame is communicated. By signaling the updated NAV timeout duration via the first frame, a reservation of the communication medium may be maintained up until a beginning of the transmission of the ELR PPDU by the first wireless device.

Particular aspects of the subject matter described in this disclosure can be implemented to realize one or more of the following potential advantages. In some examples, by indicating the updated NAV timeout duration for protection of the ELR frames, some aspects may provide for reduced interference to ELR RTS/CTS frames and provide adequate protection of the wireless communication medium for ELR RTS/CTS frames, resulting in reduced data loss and reduced latencies. In some examples, by indicating the updated NAV timeout duration calculated in accordance with the relatively lower data rate to neighboring STAs via a duration field, some aspects may enable neighboring STAs in the WLAN to update their NAV setting with relatively increased accuracy and refrain from transmitting on the wireless communication medium during an ELR/RTS signaling exchange, which may allow for ELR RTS/CTS exchanges that are uninterrupted and not impacted from conflicting transmissions (such as uplink transmissions to a central AP from neighboring STAs), resulting in increased reliability of communications and reduced power consumption as a result of reduced power loss.

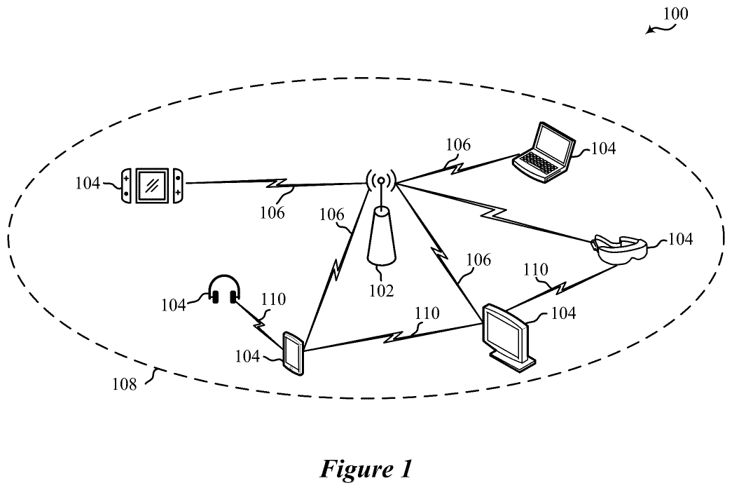

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.1 lay, 802.1 lax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations (e.g., at an end of the association operations, after all association operations have been performed), which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some aspects, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

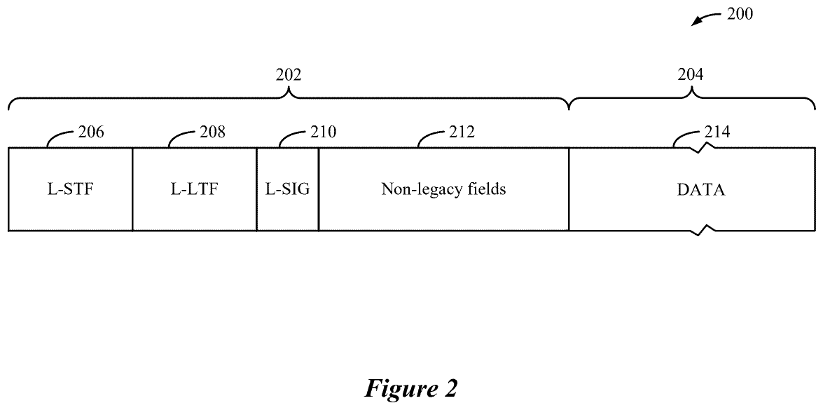

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

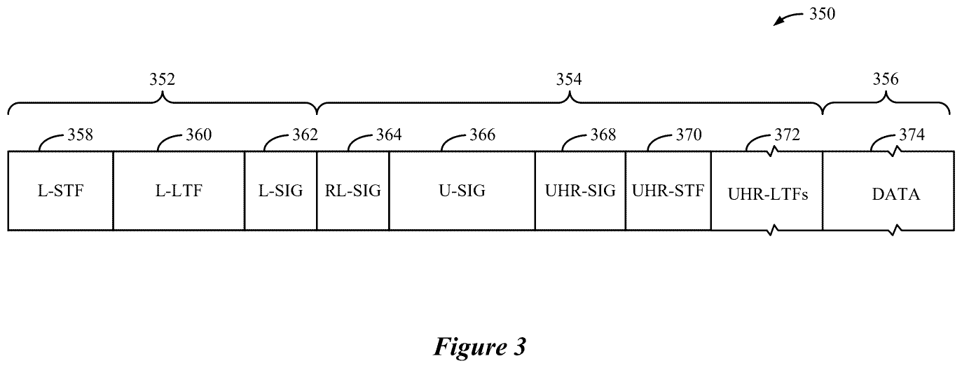

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some aspects, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (such as STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding aspects while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range (e.g., improved relationship between signal throughput and signal strength), a STA 104 and an AP 102 may support ELR frame formats. In some examples, the STA 104 and the AP 102 may support ELR frame formats to mitigate or otherwise account for a power imbalance between the STA 104 and the AP 102 (such as an uplink/downlink power imbalance). For example, the STA 104 may support a reduced range for communications relative to the AP 102 based on the STA 104 supporting a lower transmission power than the AP 102. The STA 104 and the AP 102 may implement ELR frame formats to increase a range of communications from the STA 104 to the AP 102. The use of an ELR frame format can enable the achievement of a target data rate (such as a data rate for ELR frame formats) while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats (such as non-ELR frame formats).

In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (such as a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (such as a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

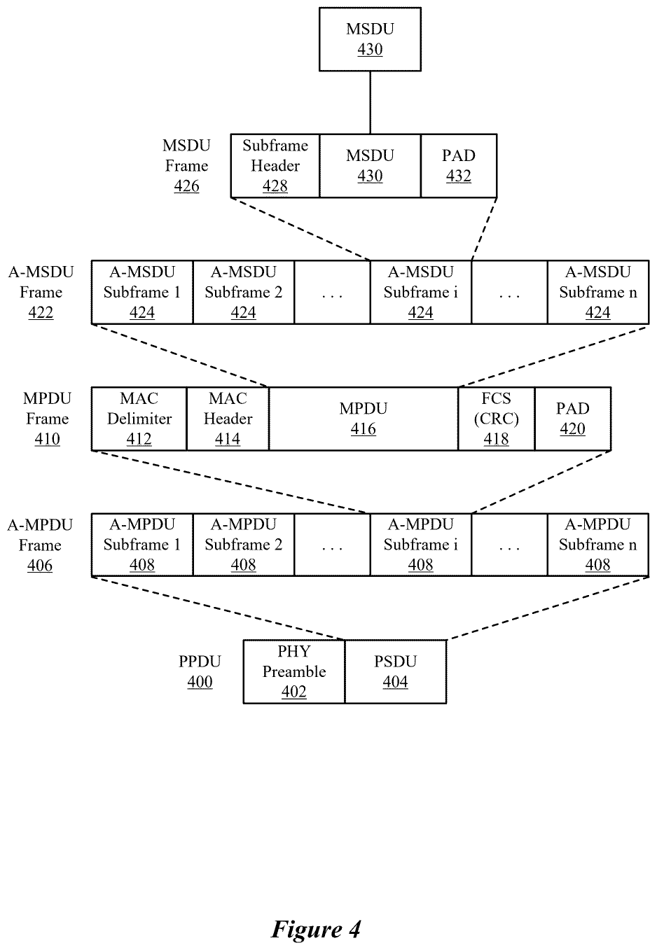

FIG. 4 shows a hierarchical format of an example PPDU 400 usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field may include a cyclic redundancy check (CRC)) and padding bits 420. The MPDU 416 may carry one or more MAC service data units (MSDUs) 416. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its NAV. The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the SIFS, the PIFS, the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a CCA and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a NAV, which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC VI), background (AC_BK), and best effort (AC BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

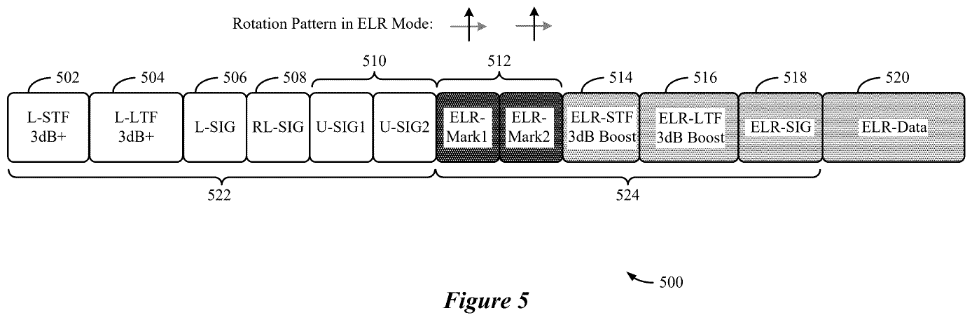

FIG. 5 shows an example of an ELR frame format 500 (such as an ELR PPDU format) that supports signaling designs for ELR transmissions. The ELR frame format 500 may implement or be implemented to realize one or more aspects of the wireless communication network 100, the PDU 200, the PPDU 350, or the PPDU 400. For example, the ELR frame format 500 may be implemented in a PDU 200, and the preamble 522 and the preamble 524 may be examples of a preamble 202. In some aspects, the preamble 524 may be an example of a non-legacy preamble and may include non-legacy fields 212. Additionally, or alternatively, the ELR frame format 500 may be implemented in a PPDU 350. In some aspects, the preamble 522 may be an example of a legacy portion 352 of the PPDU 350 and the preamble 524 may be an example of a non-legacy portion 354 of the PPDU 350. Additionally, or alternatively, the ELR frame format 500 may be implemented in a PPDU 400, and the preamble 522, the preamble 524, or both may be examples of a PHY preamble 402. An ELR data field 520 may include or be an example of a PSDU 404 or one or more MSDUs 430.

The ELR frame format 500 may be an example frame format that supports or is otherwise associated with ELR communication. For example, a wireless communication device participating in ELR communication may generate and transmit, or receive and parse, a PPDU in accordance with the ELR frame format 500. Additionally, or alternatively, a wireless communication device participating in ELR communication may generate and transmit, or receive and parse, an RTS frame, a CTS frame, an ACK frame, a quality of service (QoS) null frame, or any combination thereof, in accordance with the ELR frame format 500.

In accordance with the ELR frame format 500, a frame (such as a PDU 200, a PPDU 350, or a PPDU 400) may include an L-STF 502 (which may be power boosted by approximately +3 decibels (dB), an L-LTF 504 (which may be power boosted by approximately +3 dB,), an L-SIG field 506, an RL-SIG field 508, a U-SIG field 510 (which may include multiple symbols, such as two symbols including a first symbol U-SIG1 and a second symbol U-SIG2), an ELR field 512 (such as an ELR-mark field) including a set of ELR symbols (such as ELR-mark symbols, such as an ELR-mark1 symbol and an ELR-mark2 symbol), an ELR-STF field 514 that may be power boosted by 3 dB, an ELR-LTF field 516 that may be power boosted by 3 dB, an ELR-SIG field 518 (which may include multiple symbols, such as two symbols including a first symbol ELR-SIG1 and a second symbol ELR-SIG2), and an ELR data field 520. The ELR-STF field 514 may be the short name of UHR-STF in ELR PPDU and may include one or multiple ELR-STF symbols. The ELR-LTF field 516 may be the short name of UHR-LTF in ELR PPDU and may include one or multiple ELR-LTF symbols. The set of ELR symbols of the ELR field 512 may be associated with a rotation pattern in an ELR mode.

In some aspects, the ELR-STF field 514 may have a same length as UHR DL OFDMA with four RU52 (such as a total length or duration of 4 microseconds (μs) long in accordance with a periodicity of 0.8 μs with 5 periods), plus further +3 dB boosting. In some aspects, the ELR-LTF field 516 may have a total length or duration of 12.8 μs plus guard intervals (GIs) with 3 dB boosting, or may have a total length or duration of 25.6 μs plus GIs with or without 3 dB power boosting. In some aspects, an ELR frame (such as an ELR PPDU) may have a fixed/single mode of LTF+GI, such as one of 2×-LTF+1.6 s GI, 4×-LTF+0.8 s GI, or 4×-LTF+1.6 s GI. Without counting one or more GIs, 2×-LTF may have a length or duration of 6.4 μs and 4×-LTF may have a length or duration of 12.8 μs. Thus, a 12.8 μs ELR-LTF may be one 4×-LTF or two 2×-LTFs. A 25.6 μs ELR-LTF may be two 4×-LTFs or four 2×-LTFs.

In some aspects, the ELR frame format 500 may include a first preamble 522, which may in some cases be referred to as a legacy preamble (such as a legacy portion 352) or a non-ELR preamble. The ELR frame format 500 may additionally include a second preamble 524, which may in some cases be referred to as a non-legacy preamble (such as a non-legacy portion 354) or an ELR preamble. Because the ELR frame format 500 includes both the preamble 522 and the preamble 524, an ELR frame (such as an ELR PPDU, an ELR RTS frame, an ELR CTS frame, an ELR ACK frame, an ELR QoS null frame) may have a longer length preamble relative to non-ELR frames (such as the PPDU 350, a non-ELR RTS frame, a non-ELR CTS frame, a non-ELR ACK frame, a non-ELR QoS null frame). Additionally, or alternatively, the ELR frame may be transmitted with a data rate that is less than a data rate used to transmit non-ELR frames. For example, a non-ELR frame may be transmitted with a first data rate (such as 6 Mb/s) while an ELR frame may be transmitted with a second data rate (such as 1.7 Mb/s).

In some aspects, the ELR frame (such as an ELR PPDU) may improve link budget for PPDUs (or other frames) by a quantity of dB (such as 6 dB). In some aspects, the ELR frame format 500 may be used for transmissions in uplink and downlink (such as in 2.4 GHz bands). Alternatively, the ELR frame format 500 may be used for uplink only transmissions (such as in 5 or 6 GHz bands). In such examples, there may exist a power imbalance (such as a 6 dB power imbalance) between uplink transmissions and downlink transmissions, and the ELR frame format may be used to mitigate or otherwise reduce a difference between an uplink transmission range and a downlink transmission range that may be caused by the power imbalance.

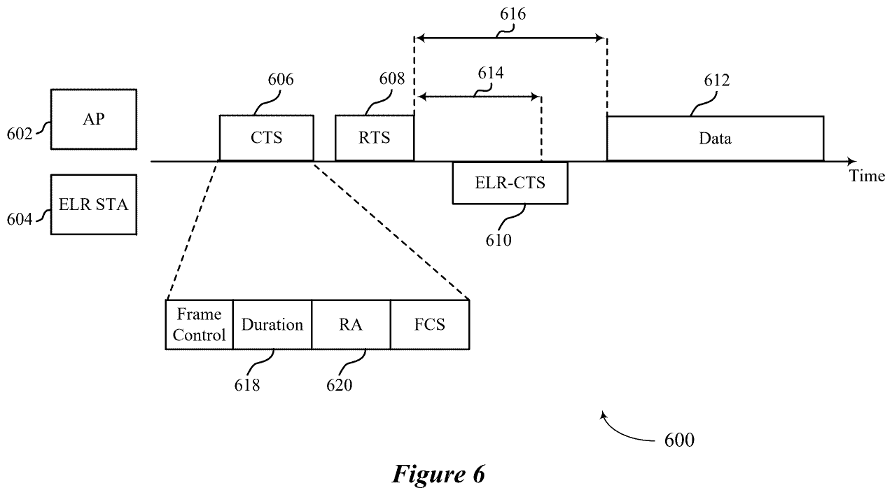

FIG. 6 shows an example of a timing diagram 600 that that shows downlink communications between a wireless AP and one or more wireless STAs (such as an ELR STA) that support protection for ELR transmissions. The timing diagram 600 may implement or be implemented to realize one or more aspects of the wireless communication network 100, the PDU 200, the PPDU 350, or the PPDU 400. For example, the timing diagram 600 may illustrate signaling between an AP 602, which may be an example of an AP 102, and an ELR STA 604, which may be an example of a STA 104. In some aspects, the timing diagram 600 may include an ELR CTS frame 610 that is formatted in accordance with the ELR frame format 500. In some aspects, the timing diagram 600 may include data 612 (such as a data frame) which may be an example of a PDU 200, a PPDU 350, or a PPDU 400 and may be formatted in accordance with the ELR frame format 500. For example, data 612 may include a non-legacy portion 354 (such as a preamble 522) and a legacy portion 352 (such as a preamble 524). The data 612 may include a PHY preamble 402 (which may include one or more non-legacy fields 212 such as ELR-specific fields) and may include a PSDU 404 carrying one or more MSDUs 430. The data 612 may include an ELR data field 520 carrying data for the ELR STA 604.

A wireless AP 602 and an ELR STA 604 may perform an exchange of an RTS frame 608 and an ELR CTS frame 610 to configure (such as schedule) a downlink transmission of data 612 (such as an ELR PPDU) from the AP 602 to the ELR STA 604. For example, the wireless AP 602 may transmit an RTS frame 608 to an ELR STA 604 using a first data rate (such as 6 Mb/s). The first data rate may be used for, correspond to, or otherwise be associated with non-ELR transmissions. The RTS frame 608 may update the NAV setting of surrounding STAs (such as bystanders) that detect the RTS frame 608. For example, the RTS frame 608 may indicate a NAV timeout duration 614 that protects a wireless communication medium and prevents transmission on the wireless communication medium for the NAV timeout duration 614. The NAV timeout duration 614 may be calculated in accordance with a length of a CTS frame that is a non-ELR CTS frame and that is communicated using the first data rate.

However, an ELR CTS frame 610 that is transmitted by the ELR STA 604 in response to the RTS frame 608 may have a length that is longer (such as four times longer) than the length of the non-ELR CTS frame. For example, the ELR CTS frame 610 may transmit duplicated information (such as four repetitions) of information to be communicated by the ELR CTS frame 610. Additionally, or alternatively, the ELR CTS frame 610 may be transmitted using a second data rate (such as 1.7 Mb/s) that is lower than the first data rate used to transmit non-ELR transmissions (such as non-ELR CTS frames). Additionally, or alternatively, the ELR CTS frame 610 may be formatted according to the ELR frame format 500 which may be different from (such as longer than) a frame format for non-ELR transmissions (such as non-ELR CTS frames). Accordingly, the ELR CTS frame may be longer (such as four times longer) than the non-ELR CTS frame and may not be protected by the duration (such as the NAV timeout duration) that is calculated based on the RTS frame 608.

After the ELR STA 604 responds to the RTS frame 608 with the ELR CTS frame 610, one or more neighboring STAs may not sense the ELR CTS frame 610. Because the duration of the ELR CTS frame 610 exceeds the NAV timeout duration calculated based on the RTS frame 608, the neighboring STAs may determine that the NAV is to be reset and may reset their respective NAV setting to zero (such as in accordance with a NAV reset rule). In accordance with resetting their respective NAV setting, the neighboring STAs may determine that the wireless communication medium is available and may transmit one or more uplink packets to the AP 602 that interfere with the ELR CTS frame 610. In some examples, because the ELR CTS frame 610 is transmitted with a low data rate relative to uplink transmissions from the surrounding STAs, the interference to the ELR CTS frame 610 may be significant and may cause data loss.

In accordance with examples described herein, to protect the ELR CTS frame 610 from interference (such as from the one or more neighboring STAs) and to reserve the wireless communication medium throughout a full duration of the ELR CTS frame 610, the AP 602 may transmit an unsolicited CTS frame 606 that indicates an updated NAV timeout duration 616. The unsolicited CTS frame 606 may be transmitted prior to the RTS frame 608 and may be transmitted using the first data rate. For example, the CTS frame 606 may set (such as update) the NAV setting of the surrounding STAs to include an updated NAV timeout duration 616 that extends up to a start of the data 612 (and accounts for the ELR CTS frame 610 being communicated with the second data rate), which may prevent a NAV reset at the surrounding STAs and protect the ELR CTS frame 610 from interference or collision on the wireless communication medium. To indicate the updated NAV timeout duration, the CTS frame 606 may indicate, in a duration field 618, a duration that is a sum of the updated NAV timeout duration 616, a short interframe space (SIFS) duration, and a duration of the RTS frame 608.

The updated NAV timeout duration 616 may be calculated in accordance with Equation 1:

$$NAV Timeout Duration = ( 2 \times aSIFSTime ) + ELR CTS Time + aRxPHYStartDelay + ( 2 \times aSlotTime ) \qquad ( 1 )$$

In Equation 1 above, aSIFSTime may be the SIFS duration, ELR CTS Time may be the duration of the ELR CTS frame 610, aRxPHYStartDelay may be a delay value associated with transmission of the data 612, and aSlotTime may be a slot duration (such as in accordance with a round trip delay) associated with communication between the AP 602 and the ELR STA 604. ELR CTS Time may be a duration of the ELR CTS frame 610 that is calculated according to a length of the ELR CTS frame 610 and according to the second data rate (such as 1.7 Mb/s) associated with ELR transmissions. In some examples, the duration of the ELR CTS frame 610 may be longer than a duration of non-ELR frames (such as the unsolicited CTS frame 606) based on the second data rate associated with ELR transmissions being lower than the first data rate associated with non-ELR transmissions. The aRxPHYStartDelay may be calculated using a length of the preamble included in the data 612 (such as the ELR PPDU). For example, the aRxPHYStartDelay may be calculated according to a first duration of a first preamble (such as the preamble 522) included in the data 612 and a second duration of a second preamble (such as the preamble 524) included in the data 612, which, when combined (such as concatenated) in the data 612, may result in a longer preamble for the data 612 relative to a non-ELR PPDU.

In some examples, the updated NAV timeout duration 616 calculated based on ELR frame durations may be in between NAV timeout durations calculated based on other types of frames corresponding to different frame durations. For example, ELR CTS frames 610 or ELR RTS frames 608 may have a first duration (such as 208 μs and 179.2 μs, respectively). The updated NAV timeout duration 616 for an ELR frame type may be calculated to be 249.2 μs. In an example, RTS frames and CTS frames of a first frame type (such as IEEE 802.11a RTS frames and IEEE 802.11a CTS frames) may have a second duration (such as 52 μs and 44 μs, respectively) that is shorter than the first duration of ELR frames. Accordingly, a NAV timeout duration for the first frame type (such as 114 μs) may be shorter than the updated NAV timeout duration 616 for the ELR frame type. In such examples, the first frame type may be associated with a NAV timeout duration that is too short to provide interference protection for the ELR CTS frame 610. In another example, RTS frames and CTS frames of a second frame type (such as IEEE 802.11b RTS frames and IEEE 802.11b CTS frames) may have a third duration (such as 352 μs and 304 μs, respectively) that is longer than the first duration of ELR frames. Accordingly, a NAV timeout duration for the second frame type (such as 374 μs) may be longer than the updated NAV timeout duration 616 for the ELR frame type. In such examples, the second frame type may be associated with higher latency relative to the ELR frame type.

The CTS frame 606 transmitted by the AP 602 may be an example of a CTS2Self frame that is addressed to a STA (such as the ELR STA 604), which may be referred to herein as a CTS2STA frame. For example, the CTS frame 606 may indicate, via a receiver address (RA) field 620, an identify of the ELR STA 604. By setting the RA field to the ELR STA 604, the AP 602 enables the ELR STA 604 to respond to the RTS frame 608 which follows the CTS frame 606 with a CTS frame (such as the ELR CTS frame 610). Additionally, or alternatively, the CTS frame 606 may be unsolicited and may be sent to the ELR STA 604 independently of any RTS frame (not sent in response to an RTS frame from the ELR STA 604). The CTS frame 606 may be transmitted to the ELR STA 604 using the first data rate.

The AP 602 may transmit the RTS frame 608 to the ELR STA 604 after transmitting the CTS frame 606. The RTS frame 608 may not update the NAV setting at the surrounding STAs. For example, the RTS frame 608 may indicate a duration that does not exceed the duration indicated via the duration field 618 of the CTS frame 606 such that surrounding STAs may not update their NAV setting in response to the RTS frame 608. In some aspects, the RTS frame 608 may request the ELR STA 604 to set protection for transmission of the data 612 (such as by indicating an updated NAV timeout duration) via the ELR CTS frame 610. In response to the RTS frame 608, the ELR STA 604 may transmit an ELR CTS frame, and a duration field of the ELR CTS frame 610 may indicate an updated duration (such as a duration that indicates an updated NAV timeout duration and covers up to the duration of the longer preamble of the data 612) relative to the duration indicated via the CTS frame 606.

The AP 602 may transmit the data 612 (such as the ELR PPDU) after receiving the ELR CTS frame 610 from the ELR STA 604. In some aspects, the AP 602 may transmit the data 612 at least partially after the indicated NAV timeout duration indicated via the CTS frame 606, but within a second NAV timeout duration indicated via the ELR CTS frame 610. The data 612 may be transmitted in accordance with the ELR frame format 500 and may include the preamble 522, the preamble 524, and the ELR data field 520. The data 612 may be transmitted in accordance with the second data rate (such as 1.7 Mb/s or 3.3 Mb/s). For example, the ELR STA 604 may refrain from transmitting additional signaling (such as an additional CTS frame) following the ELR CTS frame 610 and between the ELR CTS frame 610 and the data 612.

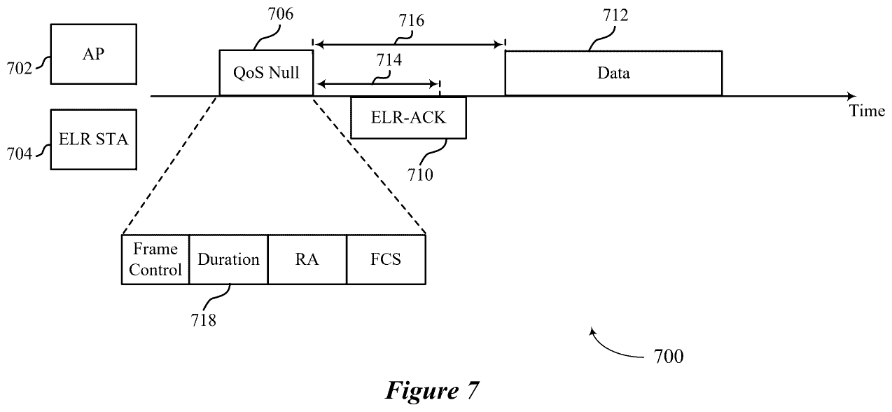

FIG. 7 shows an example of a timing diagram 700 that shows downlink communications between a wireless AP and one or more wireless STAs (such as an ELR STA) that support protection for ELR transmissions. The timing diagram 700 may implement or be implemented to realize one or more aspects of the wireless communication network 100, the PDU 200, the PPDU 350, or the PPDU 400. For example, the timing diagram 700 may illustrate signaling between an AP 702, which may be an example of an AP 102, and an ELR STA 704, which may be an example of a STA 104. In some aspects, the timing diagram 700 may include an ELR ACK frame 710 that is formatted in accordance with the ELR frame format 500. In some aspects, the timing diagram 700 may include data 712 (such as a data frame) which may be an example of a PDU 200, a PPDU 350, or a PPDU 400 and may be formatted in accordance with the ELR frame format 500. For example, data 712 may include a non-legacy portion 354 (such as a preamble 522) and a legacy portion 352 (such as a preamble 524). The data 712 may include a PHY preamble 402 (which may include one or more non-legacy fields 212 such as ELR-specific fields) and may include a PSDU 404 carrying one or more MSDUs 430. The data 712 may include an ELR data field 520 carrying data for the ELR STA 704.

A wireless AP 702 and an ELR STA 704 may perform an exchange of a QoS null frame 706 and an ELR ACK frame 710 to configure (such as schedule) a downlink transmission of data 712 (such as an ELR PPDU) from the AP 702 to the ELR STA 704. For example, the wireless AP 702 may transmit a QoS null frame 706 to an ELR STA 704 using a first data rate (such as 6 Mb/s). The QoS null frame 706 may update the NAV setting of surrounding STAs (such as bystanders) that detect the QoS null frame 706. For example, the QoS null frame 706 may indicate a NAV timeout duration 714 that protects a wireless communication medium and prevents transmission on the wireless communication medium for the NAV timeout duration 714. The NAV timeout duration 714 may be calculated in accordance with a length of an ACK frame that is a non-ELR ACK frame and that is communicated using the first data rate. However, an ELR ACK frame 710 that is transmitted by the ELR STA 704 in response to the QoS null frame 706 may have a length that is longer than the length of the non-ELR ACK frame. For example, the ELR ACK frame 710 may transmit duplicated information (such as four repetitions) of information to be communicated by the ELR ACK frame 710. Additionally, or alternatively, the ELR ACK frame 710 may be transmitted using a second data rate (such as 1.7 Mb/s) that is lower than the first data rate used to transmit non-ELR transmissions (such as non-ELR ACK frames). Additionally, or alternatively, the ELR ACK frame 710 may be formatted according to the ELR frame format 500 which may be different from (such as longer than) a frame format for non-ELR transmissions (such as non-ELR ACK frames). Accordingly, the ELR ACK frame 710 may be longer (such as four times longer) than the non-ELR ACK frame and may not be protected by the duration (such as the NAV timeout duration) that is indicated via the QoS null frame 706.

After the ELR STA 704 responds to the QoS null frame 706 with the ELR ACK frame 710, one or more neighboring STAs may not sense the ELR ACK frame 710. In some examples, the ELR ACK frame 710 may be unicast to the AP 702 (such as if the AP 702 allows only unicast) and may not be decodable by the neighboring STAs. If the duration of the ELR ACK frame 710 exceeds the NAV timeout duration indicated in the QoS null frame 706, the neighboring STAs may determine that the NAV is to be reset and may reset their respective NAV setting to zero (such as in accordance with a NAV reset rule). In accordance with resetting their respective NAV setting, the neighboring STAs may determine that the wireless communication medium is available and may transmit one or more uplink packets to the AP 702 that interfere with data 712 from the AP 702 to the ELR STA 704. In some examples, because the data 712 is transmitted with a low data rate relative to uplink transmissions from the surrounding STAs, the interference to the data 712 may be significant and may cause data loss.

In accordance with examples described herein, to protect the ELR ACK frame 710 from interference and to reserve the wireless communication medium throughout a full duration of the ELR ACK frame 710, the AP 702 may indicate, via the QoS null frame 706, an updated NAV timeout duration 716. The QoS null frame 706 may be transmitted using the first data rate. For example, the QoS null frame 706 may set (such as update) the NAV setting of the surrounding STAs to include an updated NAV timeout duration 716 that extends up to a start of the data 712 (and accounts for the ELR ACK frame 710 being communicated with the second data rate), which may prevent a NAV reset at the surrounding STAs and protect the ELR ACK frame 710 from interference or collision on the wireless communication medium. The QoS null frame 706 may indicate the updated NAV timeout period via a duration field 718.

The updated NAV timeout duration 716 may be calculated according to a length of the ELR ACK frame 710 and the second data rate. The updated NAV timeout duration 716 may be configured to extend through a full duration of the ELR ACK frame 710 and may be configured to expire at a start of the data 712.

The updated NAV timeout duration 716 may be calculated in accordance with Equation 2:

$$NAV Timeout Duration = ( 2 \times aSIFSTime ) + ELR ACK Time \qquad ( 2 )$$

In Equation 2 above, aSIFSTime may be the SIFS duration and ELR ACK Time may be the duration of the ELR ACK frame 710. ELR ACK Time may be a duration of the ELR ACK frame 710 that is calculated according to a length of the ELR ACK frame 710 and according to the second data rate (such as 1.7 Mb/s) associated with ELR transmissions.

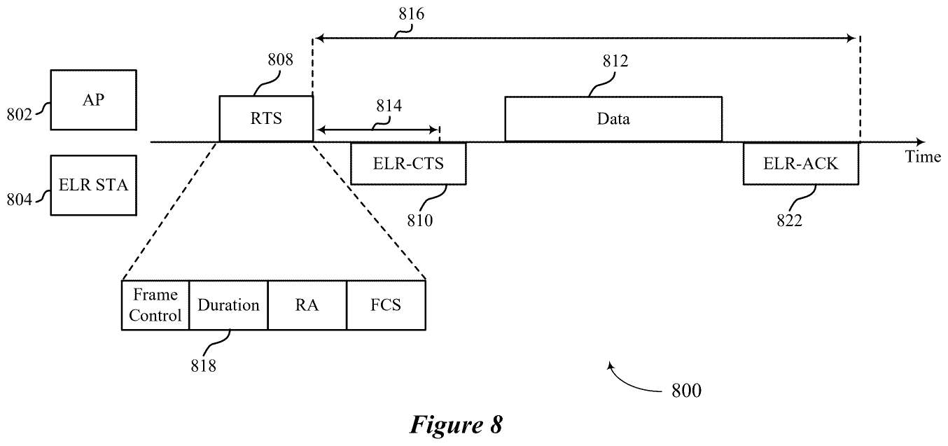

FIG. 8 shows an example of a timing diagram 800 that shows downlink communications between a wireless AP and one or more wireless STAs (such as an ELR STA) that support protection for ELR transmissions. The timing diagram 800 may implement or be implemented to realize one or more aspects of the wireless communication network 100, the PDU 200, the PPDU 350, or the PPDU 400. For example, the timing diagram 800 may illustrate signaling between an AP 802, which may be an example of an AP 102, and an ELR STA 804, which may be an example of a STA 104. In some aspects, the timing diagram 800 may include an ELR CTS frame 810 and an ELR ACK frame 822 that are formatted in accordance with the ELR frame format 500. In some aspects, the timing diagram 800 may include data 812 (such as a data frame) which may be an example of a PDU 200, a PPDU 350, or a PPDU 400 and may be formatted in accordance with the ELR frame format 500. For example, data 812 may include a non-legacy portion 354 (such as a preamble 522) and a legacy portion 352 (such as a preamble 524). The data 812 may include a PHY preamble 402 (which may include one or more non-legacy fields 212 such as ELR-specific fields) and may include a PSDU 404 carrying one or more MSDUs 430. The data 812 may include an ELR data field 520 carrying data for the ELR STA 804.

A wireless AP 802 and an ELR STA 804 may perform an exchange of an RTS frame 808 and an ELR CTS frame 810 to configure (such as schedule) a downlink transmission of data 812 (such as an ELR PPDU) from the AP 802 to the ELR STA 604. For example, the wireless AP 802 may transmit an RTS frame 808 to an ELR STA 604 using a first data rate (such as 6 Mb/s). The RTS frame 808 may update the NAV setting of surrounding STAs (such as bystanders) that detect the RTS frame 808. For example, the RTS frame 808 may indicate a NAV timeout duration 814 that protects a wireless communication medium and prevents transmission on the wireless communication medium for the NAV timeout duration 814. The NAV timeout duration 814 may be calculated in accordance with a length of a CTS frame that is a non-ELR CTS frame and that is communicated using the first data rate used by the preceding RTS frame 808. For example, the surrounding STAs may set their NAV according to a NAV timeout duration 814 that is calculated in according to Equation 3.

$$NAV Timeout Duration = ( 2 \times aSIFSTime ) + CTS Time + aRxPHYStartDelay + ( 2 \times aSlotTime ) \qquad ( 3 )$$

In Equation 3 above, CTS Time may be a duration of a non-ELR CTS frame (different from the ELR CTS frame 810) that is calculated according to a length of the non-ELR CTS frame and according to the first data rate (such as 6 Mb/s) associated with non-ELR transmissions of RTS frames (such as the RTS frame 808). aRxPHYStartDelay may be calculated according to a length of a preamble included in a non-ELR PPDU (shorter than a preamble of the data 812).

However, an ELR CTS frame 810 that is transmitted by the ELR STA 804 in response to the RTS frame 808 may have a length that is longer than the length of the non-ELR CTS frame. For example, the ELR CTS frame 810 may transmit duplicated information (such as four repetitions) of information to be communicated by the ELR CTS frame 810. Additionally, or alternatively, the ELR CTS frame 810 may be transmitted using a second data rate (such as 1.7 Mb/s) that is lower than the first data rate used to transmit non-ELR transmissions (such as non-ELR CTS frames). Additionally, or alternatively, the ELR CTS frame 810 may be formatted according to the ELR frame format 500 which may be different from (such as longer than) a frame format for non-ELR transmissions (such as non-ELR CTS frames). Accordingly, the ELR CTS frame may be longer (such as four times longer) than the non-ELR CTS frame and may not be protected by the duration (such as the NAV timeout duration 814) that is calculated by the surrounding STAs.

After the ELR STA 804 responds to the RTS frame 808 with the ELR CTS frame 810, one or more neighboring STAs may not sense the ELR CTS frame 810. Because the duration of the ELR CTS frame 810 exceeds the NAV timeout duration calculated based on the RTS frame 808, the neighboring STAs may determine that the NAV is to be reset and may reset their respective NAV setting to zero (such as in accordance with a NAV reset rule). In accordance with resetting their respective NAV setting, the neighboring STAs may determine that the wireless communication medium is available and may transmit one or more uplink packets to the AP 802 that interfere with the ELR CTS frame 810 and data 812 from the AP 802 to the ELR STA 804. In some examples, because the data 812 is transmitted with a low data rate relative to uplink transmissions from the surrounding STAs, the interference to the data 812 may be significant and may cause data loss. Additionally, or alternatively, one or more other neighboring STAs may sense the ELR CTS frame 810 but may be unable to decode the ELR CTS frame 810. These neighboring STAs may not reset their NAV setting but instead maintain the NAV setting that was previously indicated via the RTS frame 808.

In still other examples, one or more neighboring STAs that are ELR STAs may be capable of decoding the ELR CTS frame 810. If the ELR CTS frame 810 is allowed to broadcast and neighboring STAs can decode the ELR CTS frame 810 successfully, the neighboring STAs may update their NAV setting according to a duration indicated by the ELR CTS frame 810. If the ELR CTS is allowed to unicast only (but not broadcast), then the neighboring STAs may not decode the ELR CTS frame 810. In such examples, only the AP 802 can decode the ELR CTS frame 810, and the AP 802 may start to prepare for transmission of the data 812 responsive to the ELR CTS frame 810. In this way, the ELR CTS frame 810 may prevent a NAV reset at neighboring STAs that are ELR STAs (such as in examples where ELR STAs have greater sensitivity than non-ELR STAs).

In accordance with examples described herein, to protect the ELR CTS frame 810 from interference and to reserve the wireless communication medium throughout a full duration of the ELR CTS frame 810, the AP 802 may indicate, via the RTS frame 808, a duration 816 that is inclusive of the ELR CTS frame 810, the data 812, and an ELR ACK frame 822. The RTS frame 808 may be transmitted using the first data rate. For example, the RTS frame 808 may set (such as update) the NAV setting of the surrounding STAs to include a duration 816 that extends through the TXOP between the AP 802 and the ELR STA 804, including a duration of the data 812 and a duration of the ELR ACK frame 822 that is transmitted by the ELR STA using the second data rate in response to the data 812. Additionally, or alternatively, the duration 816 may account for the ELR CTS frame 810 being communicated with the second data rate, which may prevent a NAV reset at the surrounding STAs and protect the ELR CTS frame 810 from interference or collision on the wireless communication medium. The duration 816 may be indicated via a duration field 818 of the RTS frame 808.

The duration 816 indicated via the RTS frame 808 may be calculated in accordance with Equation 4:

$$Duration = ( 3 \times aSIFSTime ) + ELR CTS Time + DL ELR PPDU Time + ELR ACK Time \qquad ( 4 )$$

In Equation 3 above, aSIFSTime may be the SIFS duration, ELR CTS Time may be the duration of the ELR CTS frame 810, DL ELR PPDU Time may be a duration of the data 812, and ELR ACK Time may be duration of the ELR ACK frame 822. The duration of the ELR CTS frame 810 may be calculated according to a length of the ELR CTS frame 810 and according to the second data rate (such as 1.7 Mb/s) associated with ELR transmissions. The duration of the data 812 may be calculated according to a first duration of a first preamble (such as the preamble 522) included in the data 812 and a second duration of a second preamble (such as the preamble 524) included in the data 812, which, when combined (such as concatenated) in the data 812, may result in a longer preamble for the data 812 relative to a non-ELR PPDU.

In response to the RTS frame 808, the ELR STA 604 may transmit an ELR CTS frame, and a duration field of the ELR CTS frame 810 may indicate an updated duration (such as a duration that indicates an updated NAV timeout duration) relative to the duration indicated via the RTS frame 808.

The AP 802 may transmit the data 812 (such as the ELR PPDU) after receiving the ELR CTS frame 810 from the ELR STA 804. In some aspects, the AP 802 may transmit the data 812 within (such as entirely within) the duration 816 indicated via the RTS frame 808. The data 812 may be transmitted in accordance with the ELR frame format 500 and may include the preamble 522, the preamble 524, and the ELR data field 520. The data 812 may be transmitted in accordance with the second data rate (such as 1.7 Mb/s). In response to the data 812, the ELR STA 804 may transmit the ELR ACK frame 822 in accordance with the second data rate. The ELR ACK frame 822 may be transmitted within (such as entirely within) the duration 816.

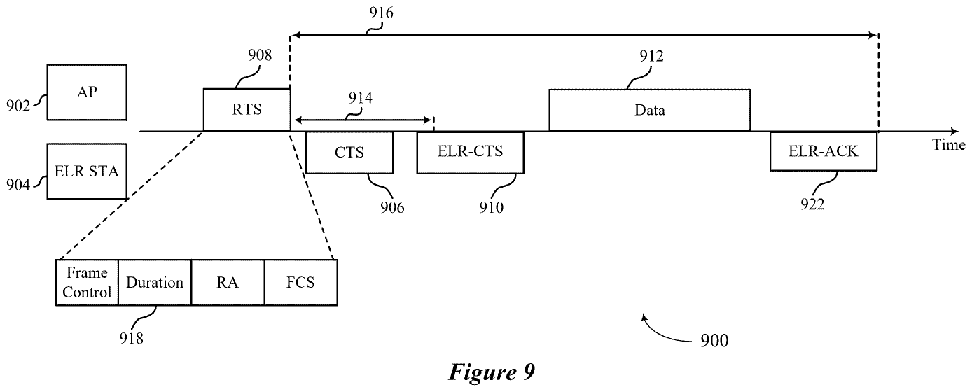

FIG. 9 shows an example of a timing diagram 900 that shows downlink communications between a wireless AP and one or more wireless STAs (such as an ELR STA) that support protection for ELR transmissions. The timing diagram 900 may implement or be implemented to realize one or more aspects of the wireless communication network 100, the PDU 200, the PPDU 350, or the PPDU 400. For example, the timing diagram 900 may illustrate signaling between an AP 902, which may be an example of an AP 102, and an ELR STA 904, which may be an example of a STA 104. In some aspects, the timing diagram 900 may include an ELR CTS frame 910 and an ELR ACK frame 922 that are formatted in accordance with the ELR frame format 500. In some aspects, the timing diagram 900 may include data 912 (such as a data frame) which may be an example of a PDU 200, a PPDU 350, or a PPDU 400 and may be formatted in accordance with the ELR frame format 500. For example, data 912 may include a non-legacy portion 354 (such as a preamble 522) and a legacy portion 352 (such as a preamble 524). The data 912 may include a PHY preamble 402 (which may include one or more non-legacy fields 212 such as ELR-specific fields) and may include a PSDU 404 carrying one or more MSDUs 430. The data 912 may include an ELR data field 520 carrying data for the ELR STA 904.

A wireless AP 902 and an ELR STA 904 may perform an exchange of an RTS frame 908 and an ELR CTS frame 910 to configure (such as schedule) a downlink transmission of data 912 (such as an ELR PPDU) from the AP 902 to the ELR STA 604. For example, the wireless AP 902 may transmit an RTS frame 908 to an ELR STA 604 using a first data rate (such as 6 Mb/s). The RTS frame 908 may update the NAV setting of surrounding STAs (such as bystanders) that detect the RTS frame 908. For example, the RTS frame 908 may indicate a NAV timeout duration 914 that protects a wireless communication medium and prevents transmission on the wireless communication medium for the NAV timeout duration 914. The NAV timeout duration 914 may be calculated in accordance with a length of a CTS frame that is a non-ELR CTS frame and that is communicated using the first data rate. For example, the surrounding STAs may set their NAV according to a NAV timeout duration 914 that is calculated in according to Equation 5.

$$NAV Timeout Duration = ( 2 \times aSIFSTime ) + CTS Time + aRxPHYStartDelay + ( 2 \times aSlotTime ) \qquad ( 5 )$$

In Equation 5 above, CTS Time may be a duration of a non-ELR CTS frame (different from the ELR CTS frame 910) that is calculated according to a length of the non-ELR CTS frame and according to the first data rate (such as 6 Mb/s) associated with non-ELR transmissions for RTS frames (such as the RTS frame 908).

However, an ELR CTS frame 910 that is transmitted by the ELR STA 904 in response to the RTS frame 908 may have a length that is longer than the length of the non-ELR CTS frame. For example, the ELR CTS frame 910 may transmit duplicated information (such as four repetitions) of information to be communicated by the ELR CTS frame 910. Additionally, or alternatively, the ELR CTS frame 910 may be transmitted using a second data rate (such as 1.7 Mb/s) that is lower than the first data rate used to transmit non-ELR transmissions (such as RTS frames). Additionally, or alternatively, the ELR CTS frame 910 may be formatted according to the ELR frame format 500 which may be different from (such as longer than) a frame format for non-ELR transmissions (such as non-ELR CTS frames). Accordingly, the ELR CTS frame may be longer (such as four times longer) than the non-ELR CTS frame and may not be protected by the duration (such as the NAV timeout duration 914) that is calculated by the surrounding STAs.

In some aspects, the ELR STA 904 may respond to the RTS frame 908 by transmitting a CTS frame 906 (such as a non-ELR CTS frame) followed by an ELR CTS frame 910. After the ELR STA 904 responds to the RTS frame 908 with both the CTS frame 906 and the ELR CTS frame 910, one or more neighboring STAs (such as non-ELR STAs) may not sense (detect) the ELR CTS frame 910 nor the CTS frame 906. Because the duration of the ELR CTS frame 910 exceeds the NAV timeout duration indicated in the RTS frame 908, the neighboring STAs may determine that the NAV is to be reset and may reset their respective NAV setting to zero (such as in accordance with a NAV reset rule). In accordance with resetting their respective NAV setting, the neighboring STAs may determine that the wireless communication medium is available and may transmit one or more uplink packets to the AP 902 that interfere with data 912 from the AP 902 to the ELR STA 904. In some examples, because the data 912 is transmitted with a low data rate relative to uplink transmissions from the surrounding STAs, the interference to the data 912 may be significant and may cause data loss. Additionally, or alternatively, one or more other neighboring STAs (such as non-ELR STAs) may be unable to sense the CTS frame 906 but may sense the ELR CTS frame 910 (and be unable to decode the ELR CTS frame 910). These neighboring STAs may not reset their NAV setting but instead maintain the NAV setting that was previously indicated via the RTS frame 908.

In still other examples, one or more neighboring STAs (such as non-ELR STAs within a threshold proximity to the ELR STA 904) may be capable of decoding the CTS frame 906. These neighboring STAs may update their NAV setting with an updated duration indicated via the CTS frame 906 in response to successfully decoding the CTS frame 906, and may refrain from transmitting on the wireless communication medium during transmission of the ELR CTS frame 910 (the ELR CTS frame 910 may have protection relative to these neighboring STAs).

In accordance with examples described herein, to protect the ELR CTS frame 910 from interference and to reserve the wireless communication medium throughout a full duration of the ELR CTS frame 910, the AP 902 may indicate, via the RTS frame 908, a duration 916 that is inclusive of the CTS frame 906, the ELR CTS frame 910, the data 912, and an ELR ACK frame 922. The RTS frame 908 may be transmitted using the first data rate. For example, the RTS frame 908 may set (such as update) the NAV setting of the surrounding STAs (such as both non-ELR STAs and ELR STAs) to include a duration 916 that extends through the TxOP between the AP 902 and the ELR STA 904, including a duration of the data 912 and a duration of the ELR ACK frame 922 that is transmitted by the ELR STA using the second data rate in response to the data 912. Additionally, or alternatively, the duration 916 may account for the ELR CTS frame 910 being communicated with the second data rate, which may prevent a NAV reset at the surrounding STAs and protect the ELR CTS frame 910 from interference or collision on the wireless communication medium. The duration 916 may be indicated via a duration field 918 of the RTS frame 908.

The duration 916 indicated via the RTS frame 908 may be calculated according to Equation 6.

$$Duration = ( 4 \times aSIFSTime ) + CTS Time + ELR CTS Time + DL ELR PPDU Time + ELR ACK Time \qquad ( 6 )$$

In Equation 6 above, aSIFSTime may be the SIFS duration, CTS Time may be a duration of the CTS frame 906, ELR CTS Time may be the duration of the ELR CTS frame 910, DL ELR PPDU Time may be a duration of the data 912, and ELR ACK Time may be duration of the ELR ACK frame 922. The duration of the CTS frame 906 may be calculated according to a length of the CTS frame 906 and according to the first data rate (such as 6 Mb/s) associated with non-ELR transmissions. The duration of the ELR CTS frame 910 may be calculated according to a length of the ELR CTS frame 910 and according to the second data rate (such as 1.7 Mb/s) associated with ELR transmissions. The duration of the data 912 may be calculated according to a first duration of a first preamble (such as the preamble 522) included in the data 912 and a second duration of a second preamble (such as the preamble 524) included in the data 912, which, when combined (such as concatenated) in the data 912, may result in a longer preamble for the data 912 relative to a non-ELR PPDU.

In response to the RTS frame 908, the ELR STA 904 may transmit both a CTS frame 906 and an ELR CTS frame 910 following the CTS frame 906, and a duration field of the ELR CTS frame 910, or a duration field of the CTS frame 906, or both, may indicate an updated duration (such as a duration that indicates an updated NAV timeout duration) relative to the duration indicated via the RTS frame 908.

The AP 902 may transmit the data 912 (such as the ELR PPDU) after receiving the ELR CTS frame 910 from the ELR STA 904. In some aspects, the AP 902 may transmit the data 912 within (such as entirely within) the duration 916 indicated via the RTS frame 908. The data 912 may be transmitted in accordance with the ELR frame format 500 and may include the preamble 522, the preamble 524, and the ELR data field 520. The data 912 may be transmitted in accordance with the second data rate (such as 1.7 Mb/s). In response to the data 912, the ELR STA 904 may transmit the ELR ACK frame 922 in accordance with the second data rate. The ELR ACK frame 922 may be transmitted within (such as entirely within) the duration 916.

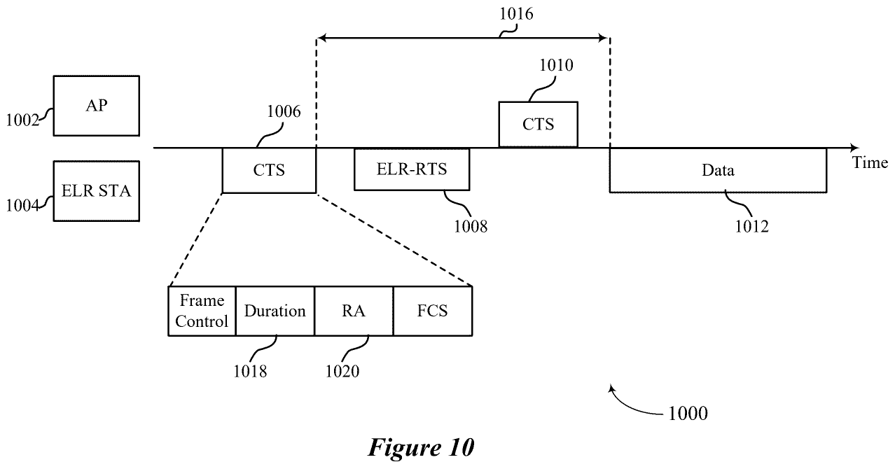

FIG. 10 shows an example of a timing diagram 1000 that that shows uplink communications between a wireless STA (such as an ELR STA) and a wireless AP that support protection for ELR transmissions. The timing diagram 1000 may implement or be implemented to realize one or more aspects of the wireless communication network 100, the PDU 200, the PPDU 350, or the PPDU 400. For example, the timing diagram 1000 may illustrate signaling between an AP 1002, which may be an example of an AP 102, and an ELR STA 1004, which may be an example of a STA 104. In some aspects, the timing diagram 1000 may include an ELR RTS frame 1008 that is formatted in accordance with the ELR frame format 500. In some aspects, the timing diagram 1000 may include data 1012 (such as a data frame) which may be an example of a PDU 200, a PPDU 350, or a PPDU 400 and may be formatted in accordance with the ELR frame format 500. For example, data 1012 may include a non-legacy portion 354 (such as a preamble 522) and a legacy portion 352 (such as a preamble 524). The data 1012 may include a PHY preamble 402 (which may include one or more non-legacy fields 212 such as ELR-specific fields) and may include a PSDU 404 carrying one or more MSDUs 430. The data 1012 may include an ELR data field 520 carrying data from an ELR STA 1004 to an AP 1002.

A wireless AP 1002 and an ELR STA 1004 may perform an exchange of an ELR RTS frame 1008 and a CTS frame 1010 to configure (such as schedule) an uplink transmission of data 1012 (such as an ELR PPDU) from the ELR STA 1004 to the AP 1002. For example, the ELR STA 1004 may transmit an ELR RTS frame 1008 to an AP 1002 using a second data rate (such as 1.7 Mb/s). The second data rate may be used for, correspond to, or otherwise be associated with ELR transmissions. The ELR RTS frame 1008 may update the NAV setting of surrounding STAs (such as bystanders) that detect the ELR RTS frame 1008. For example, the ELR RTS frame 1008 may indicate a NAV timeout duration that protects a wireless communication medium and prevents transmission on the wireless communication medium for the NAV timeout duration. The ELR RTS frame 1008 may have a length that is longer (such as four times longer) than a length of a non-ELR RTS frame. For example, the ELR RTS frame 1008 may transmit duplicated information (such as four repetitions) of information to be communicated by the ELR RTS frame 1008. Additionally, or alternatively, the ELR RTS frame 1008 may be transmitted using the second data rate (such as 1.7 Mb/s) that is lower than a first data rate used to transmit non-ELR transmissions (such as non-ELR RTS frames). Additionally, or alternatively, the ELR RTS frame 1008 may be formatted according to the ELR frame format 500 which may be different from (such as longer than) a frame format for non-ELR transmissions (such as non-ELR RTS frames). Accordingly, the ELR RTS frame 1008 may be longer (such as four times longer) than a non-ELR RTS frame.

In some examples, neighboring non-ELR STAs may not be able to decode the ELR RTS frame 1008, and the neighboring non-ELR STAs may determine that the wireless communication medium is available and may transmit one or more uplink packets to the AP 802 that interfere with the ELR RTS frame 1008. In some examples, because the ELR RTS frame 1008 is transmitted with a low data rate relative to uplink transmissions from the surrounding STAs, the interference to the ELR RTS frame 1008 may be significant and may cause data loss.

In accordance with examples described herein, to protect the ELR RTS frame 1008 from interference (such as from the one or more neighboring non-ELR STAs) and to reserve the wireless communication medium throughout a full duration of the ELR RTS frame 1008, the ELR STA 1004 may transmit an unsolicited CTS frame 1006 that indicates an updated NAV timeout duration 1016. The unsolicited CTS frame 1006 may be transmitted prior to the ELR RTS frame 1008 and may be transmitted using a first data rate (such as 6 Mb/s) associated with non-ELR transmissions. For example, the CTS frame 1006 may set (such as update) the NAV setting of the surrounding STAs to include an updated NAV timeout duration 1016 that extends up to a start of the data 1012 (and accounts for the ELR RTS frame 1008 being communicated with the second data rate), which may prevent a NAV reset at the surrounding STAs and protect the ELR RTS frame 1008 from interference or collision on the wireless communication medium. The CTS frame 1006 may indicate the updated NAV timeout duration 1016 via a duration field 1018 of the CTS frame 1006.

The updated NAV timeout duration 1016 may be calculated according to a length of the ELR RTS frame 1008 and the second data rate (such as 1.7 Mb/s) associated with ELR transmissions. The updated NAV timeout duration 1016 may be configured to extend through a full duration of the ELR RTS frame 1008 and may be configured to expire at a start of the data 1012.

The updated NAV timeout duration 1016 may be calculated in accordance with Equation 7:

$$NAV Timeout Duration = ( 3 \times aSIFSTime ) + ELR RTS Time + CTS Time \qquad ( 7 )$$

In Equation 7 above, aSIFSTime may be the SIFS duration, ELR RTS Time may be the duration of the ELR RTS frame 1008, and CTS Time may be the duration of the CTS frame 1010. ELR RTS Time may be a duration of the ELR RTS frame 1008 that is calculated according to a length of the ELR RTS frame 1008 and according to the second data rate (such as 1.7 Mb/s) associated with ELR transmissions. CTS Time may be a duration of the CTS frame 1010 that is calculated according to a length of the CTS frame 1010 and according to the first data rate (such as 6 Mb/s). In some examples, the duration of the ELR RTS frame 1008 may be longer than the duration of unsolicited CTS frame 1010 based on the second data rate associated with ELR transmissions being lower than the first data rate associated with non-ELR transmissions.

In some examples, the updated NAV timeout duration 1016 calculated based on ELR frame durations may be in between NAV timeout durations calculated based on other types of frames corresponding to different frame durations. For example, ELR CTS frames or ELR RTS frame 1008 may have a first duration (such as 208 μs and 179.2 μs, respectively). The updated NAV timeout duration 1016 for an ELR frame type may be calculated to be 249.2 μs. In an example, RTS frames and CTS frames of a first frame type (such as IEEE 802.11a RTS frames and IEEE 802.11a CTS frames) may have a second duration (such as 52 μs and 44 μs, respectively) that is shorter than the first duration of ELR frames. Accordingly, a NAV timeout duration for the first frame type (such as 114 μs) may be shorter than the updated NAV timeout duration 1016 for the ELR frame type. In such examples, the first frame type may be associated with a NAV timeout duration that is too short to provide interference protection for the ELR RTS frame 1008. In another example, RTS frames and CTS frames of a second frame type (such as IEEE 802.11b RTS frames and IEEE 802.11b CTS frames) may have a third duration (such as 352 μs and 304 μs, respectively) that is longer than the first duration of ELR frames. Accordingly, a NAV timeout duration for the second frame type (such as 374 μs) may be longer than the updated NAV timeout duration 1016 for the ELR frame type. In such examples, the second frame type may be associated with higher latency relative to the ELR frame type.

The CTS frame 1006 transmitted by the ELR STA 1004 may be an example of a CTS2Self frame that is addressed to an AP (such as the AP 1002), which may be referred to herein as a CTS2AP frame. For example, the CTS frame 1006 may indicate, via a receiver address (RA) field 1020, an identify of the AP 1002. By setting the RA field to the AP 1002, the ELR STA 1004 may enable the AP 1002 to respond to the ELR RTS frame 1008 which follows the CTS frame 1006 with a CTS frame (such as with the CTS frame 1010). Additionally, or alternatively, the CTS frame 1006 may be unsolicited and may be sent to the AP 1002 independently of any RTS frame (not sent in response to an RTS frame from the AP 1002). The CTS frame 1006 may be transmitted to the AP 1002 using the first data rate (such as 6 Mb/s).

The ELR STA 1004 may transmit the ELR RTS frame 1008 to the AP 1002 after transmitting the CTS frame 1006. The ELR RTS frame 1008 may be transmitted using the second data rate (such as 1.7 Mb/s). The ELR RTS frame 1008 may not update the NAV setting at the surrounding STAs. For example, the ELR RTS frame 1008 may indicate a duration that does not exceed the duration indicated via the duration field 1018 of the CTS frame 1006 such that surrounding STAs may not update their NAV setting in response to the ELR RTS frame 1008. In some aspects, the ELR RTS frame 1008 may request the AP 1002 to set protection for transmission of the data 1012 (such as by indicating an updated NAV timeout duration) via the CTS frame 1010. In response to the ELR RTS frame 1008, the AP 1002 may transmit the CTS frame 1010, and a duration field of the CTS frame 1010 may indicate an updated duration (such as a duration that indicates an updated NAV timeout duration) relative to the duration indicated via the CTS frame 1006.

The ELR STA 1004 may transmit the data 1012 (such as the ELR PPDU) after receiving the CTS frame 1010 from the AP 1002. In some aspects, the ELR STA 1004 may transmit the data 1012 at least partially after the indicated NAV timeout duration indicated via the CTS frame 1006, but within a second NAV timeout duration indicated via the CTS frame 1010. The data 1012 may be transmitted in accordance with the ELR frame format 500 and may include the preamble 522, the preamble 524, and the ELR data field 520. The data 1012 may be transmitted in accordance with the second data rate (such as 1.7 Mb/s). Additionally, in some aspects, communication of the data 1012 may directly follow communication of the CTS frame 1010. For example, the ELR STA 1004 may refrain from transmitting additional signaling (such as an additional CTS frame) following the CTS frame 1010 and between the CTS frame 1010 and the data 1012.

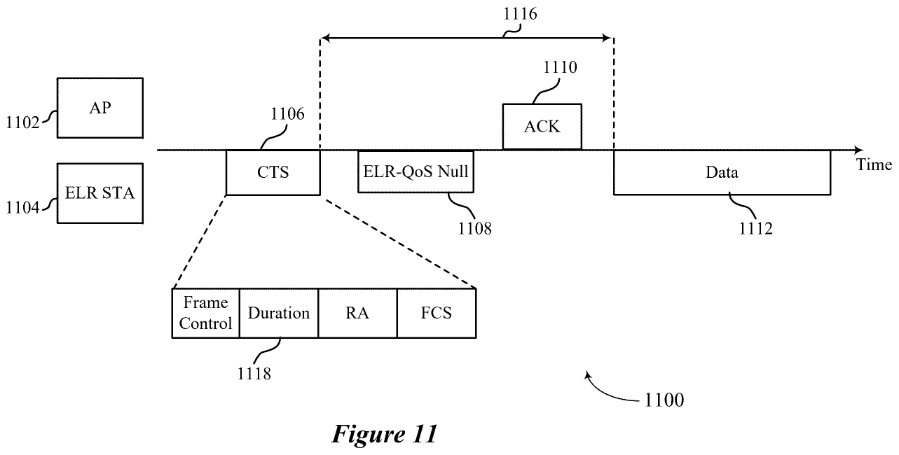

FIG. 11 shows an example of a timing diagram 1100 that that shows uplink communications between a wireless STA (such as an ELR STA) and a wireless AP that support protection for ELR transmissions. The timing diagram 1100 may implement or be implemented to realize one or more aspects of the wireless communication network 100, the PDU 200, the PPDU 350, or the PPDU 400. For example, the timing diagram 1100 may illustrate signaling between an AP 1102, which may be an example of an AP 102, and an ELR STA 1104, which may be an example of a STA 104. In some examples, the timing diagram 1100 may include an ELR QoS null frame 1108 that is formatted in accordance with the ELR frame format 500. In some aspects, the timing diagram 1100 may include data 1112 (such as a data frame) which may be an example of a PDU 200, a PPDU 350, or a PPDU 400 and may be formatted in accordance with the ELR frame format 500. For example, data 1112 may include a non-legacy portion 354 (such as a preamble 522) and a legacy portion 352 (such as a preamble 524). The data 1112 may include a PHY preamble 402 (which may include one or more non-legacy fields 212 such as ELR-specific fields) and may include a PSDU 404 carrying one or more MSDUs 430. The data 1112 may include an ELR data field 520 carrying data from an ELR STA 1104 to an AP 1102.

A wireless AP 1102 and an ELR STA 1104 may perform an exchange of an ELR QoS null frame 1108 and a ACK frame 1110 to configure (such as schedule) an uplink transmission of data 1112 (such as an ELR PPDU) from the ELR STA 1104 to the AP 1102. For example, the ELR STA 1104 may transmit an ELR QoS null frame 1108 to an AP 1102 using a second data rate (such as 1.7 Mb/s). The ELR QoS null frame 1108 may update the NAV setting of surrounding STAs (such as bystanders) that detect the ELR QoS null frame 1108. For example, the ELR QoS null frame 1108 may indicate a NAV timeout duration that protects a wireless communication medium and prevents transmission on the wireless communication medium for the NAV timeout duration. The ELR QoS null frame 1108 may have a first length that is longer than a second length of a non-ELR QoS null frame. For example, the ELR QoS null frame 1108 may transmit duplicated information (such as four repetitions) of information to be communicated by the ELR QoS null frame 1108. Additionally, or alternatively, the ELR QoS null frame 1108 may be transmitted using a second data rate (such as 1.7 Mb/s) that is lower than a first data rate used to transmit non-ELR transmissions (such as non-ELR QoS null frames). Additionally, or alternatively, the ELR QoS null frame 1108 may be formatted according to the ELR frame format 500 which may be different from (such as longer than) a frame format for non-ELR transmissions (such as non-ELR QoS null frames). Accordingly, the ELR QoS null frame 1108 may be longer (such as four times longer) than a non-ELR QoS null frame.

In some examples, neighboring non-ELR STAs may not be able to decode the ELR QoS null frame 1108, and the neighboring non-ELR STAs may determine that the wireless communication medium is available and may transmit one or more uplink packets to the AP 802 that interfere with the ELR QoS null frame 1108. In some examples, because the ELR QoS null frame 1108 is transmitted with a low data rate relative to uplink transmissions from the surrounding STAs, the interference to the ELR QoS null frame 1108 may be significant and may cause data loss.

In accordance with examples described herein, to protect the ELR QoS null frame 1108 from interference and to reserve the wireless communication medium throughout a full duration of the ELR QoS null frame 1108, the ELR STA 1104 may transmit an unsolicited CTS frame 1106 that indicates an updated NAV timeout duration 1116. The unsolicited CTS frame 1106 may be transmitted prior to the ELR QoS null frame 1108 and may be transmitted using a first data rate (such as 6 Mb/s). For example, the CTS frame 1106 may set (such as update) the NAV setting of the surrounding STAs to include an updated NAV timeout duration 1116 that extends up to a start of the data 1112 (and accounts for the ELR QoS null frame 1108 being communicated with the second data rate), which may prevent a NAV reset at the surrounding STAs and protect the ELR QoS null frame 1108 from interference or collision on the wireless communication medium. The CTS frame 1106 may indicate the updated NAV timeout duration 1116 via a duration field 1118 of the CTS frame 1106.

The updated NAV timeout duration 1116 may be calculated according to a length of the ELR QoS null frame 1108 and the second data rate (such as 1.7 Mb/s). The updated NAV timeout duration 1116 may be configured to extend through a full duration of the ELR QoS null frame 1108 and may be configured to expire at a start of the data 1112.

The updated NAV timeout duration 1116 may be calculated in accordance with Equation 8:

$$NAV Timeout Duration = ( 3 \times aSIFSTime ) + ELR QoS Null Time + ACK Time \qquad ( 8 )$$

In Equation 8 above, aSIFSTime may be the SIFS duration, ELR QoS Null Time may be the duration of the ELR QoS null frame 1108, and ACK Time may be the duration of the ACK frame 1110. ELR QoS Null Time may be a duration of the ELR QoS null frame 1108 that is calculated according to a length of the ELR QoS null frame 1108 and according to the second data rate (such as 1.7 Mb/s) associated with ELR transmissions. ACK Time may be the duration of the ACK frame 1110 that is calculated according to a length of the ACK frame 1110 and according to the first data rate (such as 6 Mb/s) associated with non-ELR transmissions.

The CTS frame 1106 transmitted by the ELR STA 1104 may be an example of a CTS2Self frame that is addressed to an AP (such as the AP 1102), which may be referred to herein as a CTS2AP frame. For example, the CTS frame 1106 may indicate, via a receiver address (RA) field 1020, an identify of the AP 1102. By setting the RA field to the AP 1102, the ELR STA 1004 may enable the AP 1102 to respond to the ELR QoS null frame 1108 which follows the CTS frame 1106 with a CTS frame (such as with the ACK frame 1110). Additionally, or alternatively, the CTS frame 1106 may be unsolicited and may be sent to the AP 1102 independently of any RTS frame (not sent in response to an RTS frame from the AP 1102). The CTS frame 1106 may be transmitted to the AP 1102 using the first data rate (such as 6 Mb/s).

The ELR STA 1104 may transmit the ELR QoS null frame 1108 to the AP 1102 after transmitting the CTS frame 1106. The ELR QoS null frame 1108 may be transmitted using the second data rate (such as 1.7 Mb/s). The ELR QoS null frame 1108 may not update the NAV setting at the surrounding STAs. For example, the ELR QoS null frame 1108 may indicate a duration that does not exceed the duration indicated via the duration field 1018 of the CTS frame 1106 such that surrounding STAs may not update their NAV setting in response to the ELR QoS null frame 1108. In some aspects, the ELR QoS null frame 1108 may request the AP 1102 to set protection for transmission of the data 1112 (such as by indicating an updated NAV timeout duration) via the ACK frame 1110. In response to the ELR QoS null frame 1108, the AP 1102 may transmit the ACK frame 1110, and a duration field of the ACK frame 1110 may indicate an updated duration (such as a duration that indicates an updated NAV timeout duration) relative to the duration indicated via the CTS frame 1106.

The ELR STA 1104 may transmit the data 1112 (such as the ELR PPDU) after receiving the ACK frame 1110 from the AP 1102. In some aspects, the ELR STA 1104 may transmit the data 1112 at least partially after the indicated NAV timeout duration indicated via the CTS frame 1106, but within a second NAV timeout duration indicated via the ACK frame 1110. The data 1112 may be transmitted in accordance with the ELR frame format 500 and may include the preamble 522, the preamble 524, and the ELR data field 520. The data 1112 may be transmitted in accordance with the second data rate (such as 1.7 Mb/s).

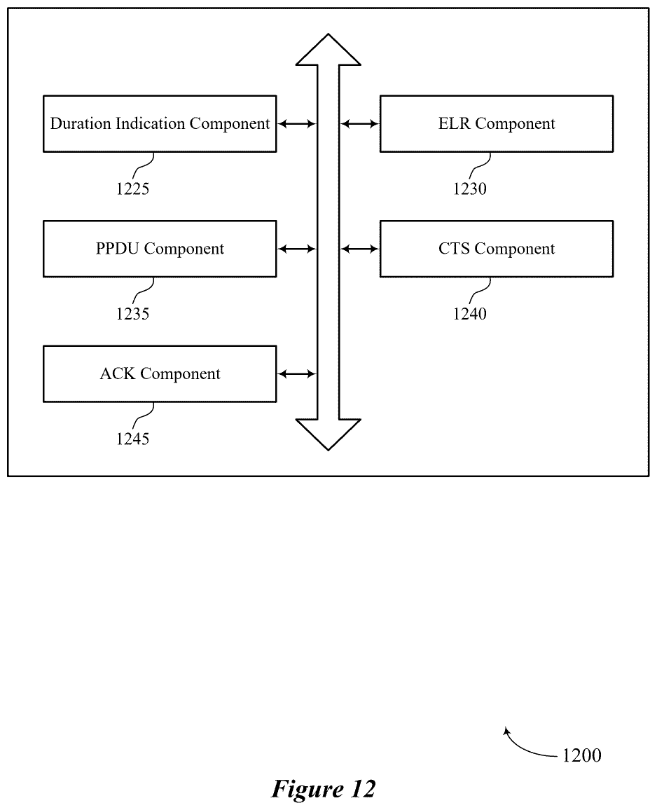

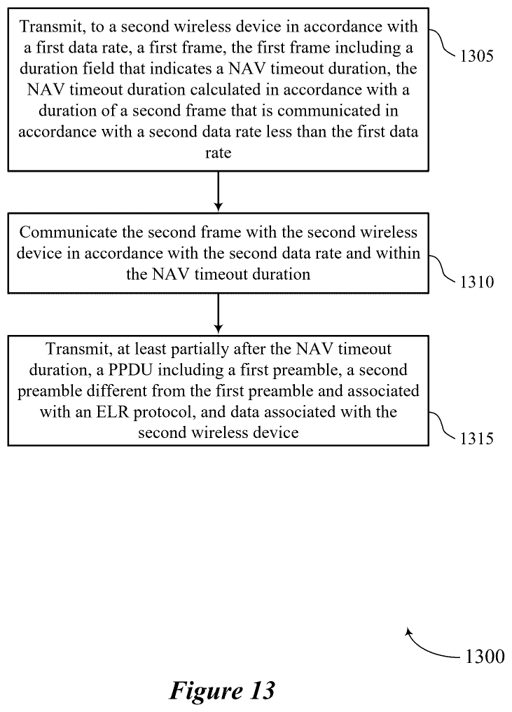

FIG. 12 shows a block diagram of an example wireless communication device 1200 (such as an ELR STA or a wireless AP) that supports protection for ELR transmissions. In some examples, the wireless communication device 1200 is configured to perform the process 1300 described with reference to FIG. 13. The wireless communication device 1200 may include one or more chips, SoCs, chipsets, packages, components or devices that individually or collectively constitute or include a processing system. The processing system may interface with other components of the wireless communication device 1200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1200 may transmit the information output from the chip. In such an example, the second interface may refer to an interface between the processing system of the chip and a reception component, such that the wireless communication device 1200 may receive information that is then passed to the processing system. In some such examples, the first interface also may obtain information, such as from the transmission component, and the second interface also may output information, such as to the reception component.

The processing system of the wireless communication device 1200 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may be configured to individually or collectively store processor-executable code that, when executed by one or more of the processors, may configure one or more of the processors to perform various functions or operations described herein (as part of a processing system). Additionally, or alternatively, in some examples, the processing system may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some aspects, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some aspects, one or more processors of the processing system include or implement one or more of the radios, RF chains or transceivers.

In some examples, the wireless communication device 1200 can be configurable or configured for use in an AP or STA, such as the AP 102 or the STA 104 described with reference to FIG. 1. In some other examples, the wireless communication device 1200 can be an AP or STA that includes such a processing system and other components including multiple antennas. The wireless communication device 1200 is capable of transmitting and receiving wireless communications in the form of, for example, wireless packets. For example, the wireless communication device 1200 can be configurable or configured to transmit and receive packets in the form of physical layer PPDUs and MPDUs conforming to one or more of the IEEE 802.11 family of wireless communication protocol standards. In some other examples, the wireless communication device 1200 can be configurable or configured to transmit and receive signals and communications conforming to one or more 3GPP specifications including those for 5G NR or 6G. In some examples, the wireless communication device 1200 also includes or can be coupled with one or more application processors which may be further coupled with one or more other memories. In some examples, the wireless communication device 1200 further includes a user interface (UI) (such as a touchscreen or keypad) and a display, which may be integrated with the UI to form a touchscreen display that is coupled with the processing system. In some examples, the wireless communication device 1200 may further include one or more sensors such as, for example, one or more inertial sensors, accelerometers, temperature sensors, pressure sensors, or altitude sensors, that are coupled with the processing system. In some examples, the wireless communication device 1200 further includes at least one external network interface coupled with the processing system that enables communication with a core network or backhaul network that enables the wireless communication device 1200 to gain access to external networks including the Internet.

The wireless communication device 1200 includes a duration indication component 1225, an ELR component 1230, a PPDU component 1235, a CTS component 1240, and an ACK component 1245. Portions of one or more of the duration indication component 1225, the ELR component 1230, the PPDU component 1235, the CTS component 1240, and the ACK component 1245 may be implemented at least in part in hardware or firmware. For example, one or more of the duration indication component 1225, the ELR component 1230, the PPDU component 1235, the CTS component 1240, and the ACK component 1245 may be implemented at least in part by at least a processor or a modem. In some examples, portions of one or more of the duration indication component 1225, the ELR component 1230, the PPDU component 1235, the CTS component 1240, and the ACK component 1245 may be implemented at least in part by a processor and software in the form of processor-executable code stored in memory.

The wireless communication device 1200 may support wireless communication in accordance with examples as disclosed herein. The duration indication component 1225 is configurable or configured to transmit, to a second wireless device in accordance with a first data rate, a first frame, the first frame including a duration field that indicates a NAV timeout duration, the NAV timeout duration calculated in accordance with a duration of a second frame that is communicated in accordance with a second data rate less than the first data rate. The ELR component 1230 is configurable or configured to communicate the second frame with the second wireless device in accordance with the second data rate and within the NAV timeout duration. The PPDU component 1235 is configurable or configured to transmit, at least partially after the NAV timeout duration, a physical layer protocol data unit (PPDU) including a first preamble, a second preamble different from the first preamble and associated with an ELR protocol, and data associated with the second wireless device.

In some examples, the first frame includes a receiver address field that indicates the second wireless device different from the first wireless device.

In some examples, the first frame includes an unsolicited CTS frame, an RTS frame, or a QoS null frame, and the second frame includes one of a second CTS frame, a second RTS frame, a second QoS null frame, or an ACK frame.

In some examples, to support protection for ELR transmissions, the duration indication component 1225 is configurable or configured to transmit, to the second wireless device after transmitting the first frame, a third RTS frame in accordance with the first data rate. In some examples, to support protection for ELR transmissions, the ELR component 1230 is configurable or configured to receive, from the second wireless device in accordance with the second data rate, the second CTS frame responsive to the third RTS frame.

In some examples, the duration field indicates a duration value that is a combination of the NAV timeout duration, a short interframe space (SIFS) duration, and a duration of the third RTS frame.

In some examples, the NAV timeout duration is further calculated in accordance with a duration of the first preamble included in the PPDU and a duration of the second preamble included in the PPDU.

In some examples, to support protection for ELR transmissions, the ELR component 1230 is configurable or configured to receive, from the second wireless device in accordance with the second data rate, the ACK frame responsive to the QoS null frame.

In some examples, the duration of the second frame is calculated in accordance with a length of the ACK frame and the second data rate.

In some examples, the ELR component 1230 is configurable or configured to receive, from the second wireless device in accordance with the second data rate, the second CTS frame responsive to the RTS frame.

In some examples, the duration field indicates a duration value that is a combination of a duration of the second CTS frame, a set of multiple short interframe space (SIFS) durations, a duration of the PPDU, and a duration of a second ACK frame, the second ACK frame received in accordance with the second data rate and responsive to the PPDU.

In some examples, the CTS component 1240 is configurable or configured to receive, from the second wireless device in accordance with the first data rate, a third CTS frame responsive to the RTS frame. In some examples, the ELR component 1230 is configurable or configured to receive, from the second wireless device after the third CTS frame, the second CTS frame in accordance with the second data rate.

In some examples, the duration field indicates a duration value that is a combination of a duration of the second CTS frame, a set of multiple short interframe space (SIFS) durations, a duration of the third CTS frame, a duration of the PPDU, and a duration of a second ACK frame, the second ACK frame received in accordance with the second data rate and responsive to the PPDU.

In some examples, the ELR component 1230 is configurable or configured to transmit, to the second wireless device after transmitting the unsolicited CTS frame, the second RTS frame in accordance with the second data rate. In some examples, the CTS component 1240 is configurable or configured to receive, from the second wireless device in accordance with the first data rate, a third CTS frame responsive to the second RTS frame.

In some examples, the duration of the second frame is calculated in accordance with a length of the second RTS frame and the second data rate.

In some examples, the ELR component 1230 is configurable or configured to transmit, to the second wireless device after transmitting the unsolicited CTS frame, the second QoS null frame in accordance with the second data rate. In some examples, the ACK component 1245 is configurable or configured to receive, from the second wireless device in accordance with the first data rate, a second ACK frame responsive to the second QoS null frame.

In some examples, the duration of the second frame is calculated in accordance with a length of the second QoS null frame and the second data rate.

In some examples, the first frame includes a single copy of first information associated with the CTS frame, the RTS frame, or the QoS null frame, the single copy of the first information in accordance with the first data rate, and the second frame includes two or more repetitions of second information associated with the second CTS frame, the second RTS frame, the second QoS null frame, or the ACK frame, the two or more repetitions of the second information in accordance with the second data rate.

In some examples, the first wireless device is one of an ELR station (STA) and an access point (AP) and the second wireless device is the other of the ELR STA or the AP.

FIG. 13 shows a flowchart illustrating an example process 1300 performable by or at a first wireless device that supports protection for ELR transmissions. The operations of the process 1300 may be implemented by a first wireless device or its components as described herein. For example, the process 1300 may be performed by a wireless communication device, such as the wireless communication device 1200 described with reference to FIG. 12, operating as or within a wireless AP or a wireless STA. In some examples, the process 1300 may be performed by a wireless AP or a wireless STA, such as one of the APs 102 or the STAs 104 described with reference to FIG. 1.

In some examples, in 1305, the first wireless device may transmit, to a second wireless device in accordance with a first data rate, a first frame, the first frame including a duration field that indicates a NAV timeout duration, the NAV timeout duration calculated in accordance with a duration of a second frame that is communicated in accordance with a second data rate less than the first data rate. The operations of 1305 may be performed in accordance with examples as disclosed herein. In some aspects, aspects of the operations of 1305 may be performed by a duration indication component 1225 as described with reference to FIG. 12.

In some examples, in 1310, the first wireless device may communicate the second frame with the second wireless device in accordance with the second data rate and within the NAV timeout duration. The operations of 1310 may be performed in accordance with examples as disclosed herein. In some aspects, aspects of the operations of 1310 may be performed by an ELR component 1230 as described with reference to FIG. 12.

In some examples, in 1315, the first wireless device may transmit, at least partially after the NAV timeout duration, a physical layer protocol data unit (PPDU) including a first preamble, a second preamble different from the first preamble and associated with an ELR protocol, and data associated with the second wireless device. The operations of 1315 may be performed in accordance with examples as disclosed herein. In some aspects, aspects of the operations of 1315 may be performed by a PPDU component 1235 as described with reference to FIG. 12.

The following provides an overview of aspects of the present disclosure:

Aspect 1: A method for wireless communication at a first wireless device, comprising: transmitting, to a second wireless device in accordance with a first data rate, a first frame, the first frame comprising a duration field that indicates a network allocation vector (NAV) timeout duration, the NAV timeout duration calculated in accordance with a duration of a second frame that is communicated in accordance with a second data rate less than the first data rate; communicating the second frame with the second wireless device in accordance with the second data rate and within the NAV timeout duration; and transmitting, at least partially after the NAV timeout duration, a physical layer protocol data unit (PPDU) comprising a first preamble, a second preamble different from the first preamble and associated with an enhanced long range (ELR) protocol, and data associated with the second wireless device.

Aspect 2: The method of aspect 1, wherein the first frame comprises a receiver address field that indicates the second wireless device different from the first wireless device.

Aspect 3: The method of any of aspects 1 through 2, wherein the first data rate is associated with a non-ELR protocol and the second data rate is associated with the ELR protocol, and the second data rate is less than the first data rate in accordance with the ELR protocol.

Aspect 4: The method of any of aspects 1 through 3, wherein the first frame includes an unsolicited clear to send (CTS) frame associated with a non-ELR protocol and the second frame comprises an ELR-CTS frame transmitted by the first wireless device.

Aspect 5: The method of any of aspects 1 through 4, wherein the first frame includes an unsolicited CTS frame associated with a non-ELR protocol and the second frame comprises an ELR request to send (RTS) frame received by the first wireless device.

Aspect 6: The method of any of aspects 1 through 5, wherein the first frame comprises an unsolicited clear to send (CTS) frame, an RTS frame, or a quality of service (QoS) null frame, and the second frame comprises one of a second CTS frame, a second RTS frame, a second QoS null frame, or an ACK frame.

Aspect 7: The method of aspect 6, wherein the first frame comprises the unsolicited CTS frame and the second frame comprises the second CTS frame, further comprising: transmitting, to the second wireless device after transmitting the first frame, a third RTS frame in accordance with the first data rate; and receiving, from the second wireless device in accordance with the second data rate, the second CTS frame responsive to the third RTS frame.

Aspect 8: The method of aspect 7, wherein the duration field in the first frame indicates a duration value that is a combination of the NAV timeout duration, a short interframe space (SIFS) duration, and a duration of the third RTS frame.

Aspect 9: The method of any of aspects 7 through 8, wherein the NAV timeout duration is further calculated in accordance with a duration of the second CTS frame with the second data rate.

Aspect 10: The method of aspect 6, wherein the first frame comprises the QoS null frame and the second frame comprises the ACK frame, further comprising: receiving, from the second wireless device in accordance with the second data rate, the ACK frame responsive to the QoS null frame, wherein the duration field in the first frame indicates a duration value that is in accordance with a length of the ACK frame and the second data rate and is in accordance with a plurality of short interframe space (SIFS) durations.

Aspect 11: The method of aspect 6, wherein the first frame comprises the RTS frame and the second frame comprises the second CTS frame, further comprising: receiving, from the second wireless device in accordance with the second data rate, the second CTS frame responsive to the RTS frame, wherein the duration field in the first frame indicates a duration value that is a combination of a duration of the second CTS frame, a plurality of short interframe space (SIFS) durations, a duration of the PPDU, and a duration of a second ACK frame, the second ACK frame received in accordance with the second data rate and responsive to the PPDU.

Aspect 12: The method of any of aspects 6 through 11, wherein the first frame comprises the RTS frame and the second frame comprises the second CTS frame, further comprising: receiving, from the second wireless device in accordance with the first data rate, a third CTS frame responsive to the RTS frame; and receiving, from the second wireless device after the third CTS frame, the second CTS frame in accordance with the second data rate.

Aspect 13: The method of aspect 12, wherein the duration field in the first frame indicates a duration value that is a combination of a duration of the second CTS frame, a plurality of short interframe space (SIFS) durations, a duration of the third CTS frame, a duration of the PPDU, and a duration of a second ACK frame, the second ACK frame received in accordance with the second data rate and responsive to the PPDU.

Aspect 14: The method of any of aspects 6 through 13, wherein the first frame comprises the unsolicited CTS frame and the second frame comprises the second RTS frame, further comprising: transmitting, to the second wireless device after transmitting the unsolicited CTS frame, the second RTS frame in accordance with the second data rate; and receiving, from the second wireless device in accordance with the first data rate, a third CTS frame responsive to the second RTS frame.

Aspect 15: The method of aspect 14, wherein the duration field in the first frame indicates a duration value that is in accordance with a length of the second RTS frame and the second data rate, is in accordance with a length of the third CTS frame and the first data rate, and is in accordance with a plurality of short interframe space (SIFS) durations.

Aspect 16: The method of any of aspects 6 through 15, wherein the first frame comprises the unsolicited CTS frame and the second frame comprises the second QoS null frame, further comprising: transmitting, to the second wireless device after transmitting the unsolicited CTS frame, the second QoS null frame in accordance with the second data rate; and receiving, from the second wireless device in accordance with the first data rate, a second acknowledgement frame responsive to the second QoS null frame.

Aspect 17: The method of aspect 16, wherein the duration field in the first frame indicates a duration value that is in accordance with a length of the second QoS null frame and the second data rate, is in accordance with a length of the second ACK frame and the first data rate, and is in accordance with a plurality of short interframe space (SIFS) durations.

Aspect 18: The method of any of aspects 6 through 17, wherein the first frame comprises a single copy of first information associated with the unsolicited CTS frame, the RTS frame, or the QoS null frame, the single copy of the first information in accordance with the first data rate, and the second frame comprises two or more repetitions of second information associated with the second CTS frame, the second RTS frame, the second QoS null frame, or the ACK frame, the two or more repetitions of the second information in accordance with the second data rate.

Aspect 19: The method of any of aspects 1 through 18, wherein the first wireless device is one of an ELR STA and an AP and the second wireless device is the other of the ELR STA or the AP.

Aspect 20: An apparatus for wireless communication at a first wireless device, comprising one or more memories storing processor-executable code, and one or more processors coupled with the one or more memories and individually or collectively operable to execute the code to cause the first wireless device to perform a method of any of aspects 1 through 16.

Aspect 21: An apparatus for wireless communication at a first wireless device, comprising at least one means for performing a method of any of aspects 1 through 16.

Aspect 22: A non-transitory computer-readable medium storing code for wireless communication at a first wireless device, the code comprising instructions executable by one or more processors to perform a method of any of aspects 1 through 16.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication at a first wireless device, comprising:
a processing system that includes processor circuitry and memory circuitry that stores code, the processing system configured to cause the apparatus to:
transmit, to a second wireless device in accordance with a first data rate, a first frame, the first frame comprising a duration field that indicates a network allocation vector (NAV) timeout duration, the NAV timeout duration calculated in accordance with a duration of a second frame that is communicated in accordance with a second data rate less than the first data rate;
communicate the second frame with the second wireless device in accordance with the second data rate and within the NAV timeout duration; and
transmit, at least partially after the NAV timeout duration, a physical layer protocol data unit (PPDU) comprising a first preamble, a second preamble different from the first preamble and associated with an enhanced long range (ELR) protocol, and data associated with the second wireless device.

2. The apparatus of claim 1, wherein the first frame comprises a receiver address field that indicates the second wireless device different from the first wireless device.

3. The apparatus of claim 1, wherein the first data rate is associated with a non-ELR protocol and the second data rate is associated with the ELR protocol, and wherein the second data rate is less than the first data rate in accordance with the ELR protocol.

4. The apparatus of claim 1, wherein the first frame comprises an unsolicited clear to send (CTS) frame associated with a non-ELR protocol and the second frame comprises an ELR-CTS frame transmitted by the first wireless device.

5. The apparatus of claim 1, wherein the first frame comprises an unsolicited clear to send (CTS) frame associated with a non-ELR protocol and the second frame comprises an ELR request to send (RTS) frame received by the first wireless device.

6. The apparatus of claim 1, wherein the first frame comprises an unsolicited clear to send (CTS) frame, a request to send (RTS) frame, or a quality of service (QoS) null frame, and the second frame comprises one of a second CTS frame, a second RTS frame, a second QoS null frame, or an acknowledgement (ACK) frame.

7. The apparatus of claim 6, wherein the first frame comprises the unsolicited CTS frame and the second frame comprises the second CTS frame, the processing system further configured to cause the apparatus to:
transmit, to the second wireless device after transmitting the first frame, a third RTS frame in accordance with the first data rate; and
receive, from the second wireless device in accordance with the second data rate, the second CTS frame responsive to the third RTS frame.

8. The apparatus of claim 7, wherein the duration field in the first frame indicates a duration value that is a combination of the NAV timeout duration, a short interframe space (SIFS) duration, and a duration of the third RTS frame.

9. The apparatus of claim 7, wherein the NAV timeout duration is further calculated in accordance with a duration of the second CTS frame with the second data rate.

10. The apparatus of claim 6, wherein the first frame comprises the QoS null frame and the second frame comprises the ACK frame, the processing system further configured to cause the apparatus to:
receive, from the second wireless device in accordance with the second data rate, the ACK frame responsive to the QoS null frame, wherein the duration field in the first frame indicates a duration value that is in accordance with a length of the ACK frame and the second data rate and is in accordance with a plurality of short interframe space (SIFS) durations.

11. The apparatus of claim 6, wherein the first frame comprises the RTS frame and the second frame comprises the second CTS frame, the processing system further configured to cause the apparatus to:
receive, from the second wireless device in accordance with the second data rate, the second CTS frame responsive to the RTS frame, wherein the duration field in the first frame indicates a duration value that is a combination of a duration of the second CTS frame, a plurality of short interframe space (SIFS) durations, a duration of the PPDU, and a duration of a second ACK frame, the second ACK frame received in accordance with the second data rate and responsive to the PPDU.

12. The apparatus of claim 6, wherein the first frame comprises the RTS frame and the second frame comprises the second CTS frame, the processing system further configured to cause the apparatus to:
receive, from the second wireless device in accordance with the first data rate, a third CTS frame responsive to the RTS frame; and
receive, from the second wireless device after the third CTS frame, the second CTS frame in accordance with the second data rate.

13. The apparatus of claim 12, wherein the duration field in the first frame indicates a duration value that is a combination of a duration of the second CTS frame, a plurality of short interframe space (SIFS) durations, a duration of the third CTS frame, a duration of the PPDU, and a duration of a second ACK frame, the second ACK frame received in accordance with the second data rate and responsive to the PPDU.

14. The apparatus of claim 6, wherein the first frame comprises the unsolicited CTS frame and the second frame comprises the second RTS frame, the processing system further configured to cause the apparatus to:
transmit, to the second wireless device after transmitting the unsolicited CTS frame, the second RTS frame in accordance with the second data rate; and
receive, from the second wireless device in accordance with the first data rate, a third CTS frame responsive to the second RTS frame.

15. The apparatus of claim 14, wherein the duration field in the first frame indicates a duration value that is in accordance with a length of the second RTS frame and the second data rate, is in accordance with a length of the third CTS frame and the first data rate, and is in accordance with a plurality of short interframe space (SIFS) durations.

16. The apparatus of claim 6, wherein the first frame comprises the unsolicited CTS frame and the second frame comprises the second QoS null frame, the processing system further configured to cause the apparatus to:
transmit, to the second wireless device after transmitting the unsolicited CTS frame, the second QoS null frame in accordance with the second data rate; and
receive, from the second wireless device in accordance with the first data rate, a second acknowledgement frame responsive to the second QoS null frame.

17. The apparatus of claim 16, wherein the duration field in the first frame indicates a duration value that is in accordance with a length of the second QoS null frame and the second data rate, is in accordance with a length of the second ACK frame and the first data rate, and is in accordance with a plurality of short interframe space (SIFS) durations.

18. The apparatus of claim 6, wherein the first frame comprises a single copy of first information associated with the CTS frame, the RTS frame, or the QoS null frame, the single copy of the first information in accordance with the first data rate, and the second frame comprises two or more repetitions of second information associated with the second CTS frame, the second RTS frame, the second QoS null frame, or the ACK frame, the two or more repetitions of the second information in accordance with the second data rate.

19. A method for wireless communication at a first wireless device, comprising:
transmitting, to a second wireless device in accordance with a first data rate, a first frame, the first frame comprising a duration field that indicates a network allocation vector (NAV) timeout duration, the NAV timeout duration calculated in accordance with a duration of a second frame that is communicated in accordance with a second data rate less than the first data rate;
communicating the second frame with the second wireless device in accordance with the second data rate and within the NAV timeout duration; and
transmitting, at least partially after the NAV timeout duration, a physical layer protocol data unit (PPDU) comprising a first preamble, a second preamble different from the first preamble and associated with an enhanced long range (ELR) protocol, and data associated with the second wireless device.

20. The method of claim 19, wherein the first frame comprises a receiver address field that indicates the second wireless device different from the first wireless device.

21. The method of claim 19, wherein the first data rate is associated with a non-ELR protocol and the second data rate is associated with the ELR protocol, and wherein the second data rate is less than the first data rate in accordance with the ELR protocol.

22. The method of claim 19, wherein the first frame comprises an unsolicited clear to send (CTS) frame, a request to send (RTS) frame, or a quality of service (QoS) null frame, and the second frame comprises one of a second CTS frame, a second RTS frame, a second QoS null frame, or an acknowledgement (ACK) frame.

23. The method of claim 22, wherein the first frame comprises the unsolicited CTS frame and the second frame comprises the second CTS frame, further comprising:
transmitting, to the second wireless device after transmitting the first frame, a third RTS frame in accordance with the first data rate; and
receiving, from the second wireless device in accordance with the second data rate, the second CTS frame responsive to the third RTS frame.

24. The method of claim 22, wherein the first frame comprises the QoS null frame and the second frame comprises the ACK frame, further comprising:
receiving, from the second wireless device in accordance with the second data rate, the ACK frame responsive to the QoS null frame, wherein the duration field in the first frame indicates a duration value that is in accordance with a length of the ACK frame and the second data rate and is in accordance with a plurality of short interframe space (SIFS) durations.

25. The method of claim 22, wherein the first frame comprises the RTS frame and the second frame comprises the second CTS frame, further comprising:
receiving, from the second wireless device in accordance with the second data rate, the second CTS frame responsive to the RTS frame, wherein the duration field in the first frame indicates a duration value that is a combination of a duration of the second CTS frame, a plurality of short interframe space (SIFS) durations, a duration of the PPDU, and a duration of a second ACK frame, the second ACK frame received in accordance with the second data rate and responsive to the PPDU.

26. The method of claim 22, wherein the first frame comprises the RTS frame and the second frame comprises the CTS frame, further comprising:
receiving, from the second wireless device in accordance with the first data rate, a third CTS frame responsive to the RTS frame; and
receiving, from the second wireless device after the third CTS frame, the second CTS frame in accordance with the second data rate.

27. The method of claim 22, wherein the first frame comprises the unsolicited CTS frame and the second frame comprises the second RTS frame, further comprising:
transmitting, to the second wireless device after transmitting the unsolicited CTS frame, the second RTS frame in accordance with the second data rate; and
receiving, from the second wireless device in accordance with the first data rate, a third CTS frame responsive to the second RTS frame.

28. The method of claim 22, wherein the first frame comprises the unsolicited CTS frame and the second frame comprises the second QoS null frame, further comprising:
transmit, to the second wireless device after transmitting the unsolicited CTS frame, the second QoS null frame in accordance with the second data rate; and
receive, from the second wireless device in accordance with the first data rate, a second acknowledgement frame responsive to the second QoS null frame.

29. An apparatus for wireless communication at a first wireless device, comprising:
means for transmitting, to a second wireless device in accordance with a first data rate, a first frame, the first frame comprising a duration field that indicates a network allocation vector (NAV) timeout duration, the NAV timeout duration calculated in accordance with a duration of a second frame that is communicated in accordance with a second data rate less than the first data rate;
means for communicating the second frame with the second wireless device in accordance with the second data rate and within the NAV timeout duration; and
means for transmitting, at least partially after the NAV timeout duration, a physical layer protocol data unit (PPDU) comprising a first preamble, a second preamble different from the first preamble and associated with an enhanced long range (ELR) protocol, and data associated with the second wireless device, the second preamble.

30. The apparatus of claim 29, wherein the first frame comprises an unsolicited clear to send (CTS) frame, a request to send (RTS) frame, or a quality of service (QoS) null frame, and the second frame comprises one of a second CTS frame, a second RTS frame, a second QoS null frame, or an acknowledgement (ACK) frame.
